(19) United States
(12) Patent Application Publication
(10) Pub. No.: US 2026/0186683 A1
(43) Pub. Date: Jul. 2, 2026

(54) METHODS FOR REDUNDANT ARRAY OF INDEPENDENT DISKS STRIPING AND APPARATUSES THEREOF

(71) Applicant: Yangtze Memory Technologies Co., Ltd., Wuhan (CN)

(72) Inventors: Biao Yang, Wuhan (CN); Jie Wan, Wuhan (CN); Yonggang Chen, Wuhan (CN)

(21) Appl. No.: 19/011,378

(22) Filed: Jan. 6, 2025

(30) Foreign Application Priority Data
Dec. 30, 2024 (CN) 202411975016.4

(51) Int. Cl. G06F 3/06

(52) U.S. Cl. CPC G06F 3/065; G06F 3/0619; G06F 3/0688

(57) ABSTRACT

In some aspects, a memory system is provided. The memory system may include a memory device and a memory controller. The memory device may include one or more dies each including a plurality of planes. Each of the plurality of planes may include a subset of pages to form a striping group in the one or more dies, and one word line of multiple word lines may be coupled to R strings in each plane to form R pages. The striping group may form J stripes. A ratio of J to R can be a value greater than 1 and less than 2. The memory controller may be coupled with the memory device and configured to receive data portions corresponding to the J stripes; generate J parity data portions based on the data portions; and control the memory device to store the J parity data portions.

### CROSS-REFERENCE TO RELATED APPLICATIONS

This application claims the benefit of priority to Chinese Application No. 202411975016.4, filed on Dec. 30, 2024, which is hereby incorporated by reference in its entirety.

### BACKGROUND

The present disclosure generally relates to data storage methods and apparatuses, and more particularly, to techniques for Redundant Array of Independent Disks (RAID) striping and related apparatuses.

With the rapid growth of the Internet and the increasing reliance on mission-critical applications, the necessity of preserving data integrity and ensuring uninterrupted access to critical information is critical. To meet these demands, RAID algorithms have been developed to improve performance and reliability, reduce power consumption, and increase the scalability of data storage, particularly in NAND-based memory devices. These algorithms employ techniques such as data striping, mirroring, and parity-based error correction to construct highly reliable and efficient storage systems capable of storing large amounts of data while minimizing the risk of data loss or corruption.

### SUMMARY

In some aspects, a memory system is provided. The memory system may include a memory device and a memory controller. The memory device may include one or more dies each including a plurality of planes. Each of the plurality of planes may include a subset of pages to form a striping group in the one or more dies, and one word line of multiple word lines may be coupled to R strings in each plane to form R pages. The striping group may form J stripes. A ratio of J to R can be a value greater than 1 and less than 2. The memory controller may be coupled with the memory device and configured to receive data portions corresponding to the J stripes; generate J parity data portions based on the data portions; and control the memory device to store the J parity data portions.

In some implementations, the ratio of J to R can be equal to 1.5.

In some implementations, the ratio of J to R can be equal to 1.25.

In some implementations, the ratio of J to R can be equal to 1.75.

In some implementations, the memory controller may be further configured to: according to a programming failure distribution associated with the memory device, determine the ratio of J to R.

In some implementations, in the subset of pages, two i^{th} pages of a same string, coupled to two adjacent word lines of the multiple word lines, may belong to two stripes of the J stripes, 1≤i≤R.

In some implementations, in the subset of pages, two adjacent pages, coupled to a same word line of the multiple word lines, may belong to two stripes of the J stripes.

In some implementations, in the subset of pages, each of a first page, a second page, and a third page, coupled to a same word line, may belong to a respective stripe of the J stripes. The second page and the third page may be adjacent to the first page corresponding to the same word line.

In some implementations, in the subset of pages, each of a fourth page, a fifth page, and a sixth page, respectively coupled to a first word line, a second word line, and a third word line, may belong to a respective stripe of the J stripes. The first word line and third word line may be adjacent to the second word line. The fourth, fifth, and sixth pages may correspond to a same string.

In some implementations, a first stripe of the J stripes may include a first set of pages and a second set of pages. The first set of pages may include, from each subset of pages, an i^{th} page coupled to a first word line of the multiple word lines, 1≤i≤R; and the second set of pages may include, from each subset of pages, a j^{th} page coupled to a second word line adjacent to the first word line, 1≤j≤R, and j≠i.

In some implementations, a first stripe of the J stripes may include a third set of pages and a fourth set of pages. The third set of pages may include, from each subset of pages, an i^{th} page coupled to a first word line of the multiple word lines, 1≤i≤R; and the fourth set of pages may include, from each subset of pages, an i^{th} page coupled to a third word line that can be non-adjacent to the first word line.

In some implementations, the memory controller may be further configured to perform an encoding operation on the data portions to generate the J parity data portions.

In some implementations, the memory controller may be further configured to: receive a first data portion corresponding to a first page of the subset of pages, and a second data portion corresponding to a second page of the subset of pages; and perform an exclusive OR (XOR) operation on the first data portion and the second data portion.

In some implementations, one stripe of the J stripes corresponds to one parity data portion of the J parity data portions; and the memory controller may be further configured to control the memory device to store the parity data portion of the J parity data portions in a last page of the stripe.

In some implementations, the memory controller may be further configured to in response to a read failure associated with a third data portion: locate the third data portion, corresponding to the read failure, in the memory device; obtain remaining data portions and a first parity data portion in a stripe with the third data portion; generate a reconstructed data portion based on the first parity data portion and the remaining data portions; and replace the third data portion with the reconstruction data portion.

In some implementations, the memory controller may be configured to: perform XOR operations on the remaining data portions and the first parity data portion to generate the reconstructed data portion.

In some implementations, the memory controller may be further configured to: when no read failure is associated with the J stripes, send a notification signal to a host coupled to the memory controller.

In some implementations, the memory device may include NAND memory cells, and the memory controller may include a Flash memory controller.

In some aspects, a memory controller including a processor and an interface (I/F) circuit coupled with a memory device is provided. The memory device may include one or more dies each including a plurality of planes. Each of the plurality of planes may include a subset of pages, corresponding to multiple word lines, to form a striping group in the one or more dies. One word line of the multiple word lines may be coupled to R strings in each plane to form R pages. The striping group may form J stripes. Each of R and J can be an integer, and a ratio of J to R can be a value greater than 1 and less than 2. The processor may be coupled with the I/F circuit and configured to: receive data portions corresponding to the J stripes; generate J parity data portions based on the data portions; and control the I/F circuit to send a write command, the data portions, and the J parity data portions to the memory device to store the J parity data portions and the data portions in the memory device.

In some implementations, the ratio of J to R can be equal to 1.5.

In some implementations, the ratio of J to R can be equal to 1.25.

In some implementations, the ratio of J to R can be equal to 1.75.

In some implementations, the processor may be further configured to: according to a programming failure distribution associated with the memory device, determine the ratio of J to R.

In some implementations, in the subset of pages, two i^{th} pages of a same string, coupled to two adjacent word lines of the multiple word lines, may belong to two stripes of the J stripes, 1≤i≤R.

In some implementations, in the subset of pages, two adjacent pages, coupled to a same word line of the multiple word lines, may belong to two stripes of the J stripes.

In some implementations, in the subset of pages, each of a first page, a second page, and a third page, coupled to a same word line, may belong to a respective stripe of the J stripes. The second page and the third page may be adjacent to the first page corresponding to the same word line.

In some implementations, in the subset of pages, each of a fourth page, a fifth page, and a sixth page, respectively coupled to a first word line, a second word line, and a third word line, may belong to a respective stripe of the J stripes. The first word line and third word line may be adjacent to the second word line. The fourth, fifth, and sixth pages may correspond to a same string.

In some implementations, a first stripe of the J stripes may include a first set of pages and a second set of pages. The first set of pages may include, from each subset of pages, an i^{th} page coupled to a first word line of the multiple word lines, 1≤i≤R; and the second set of pages may include, from each subset of pages, a j^{th} page coupled to a second word line adjacent to the first word line, 1≤j≤R, and j≠i.

In some implementations, a first stripe of the J stripes may include a third set of pages and a fourth set of pages. The third set of pages may include, from each subset of pages, an i^{th} page coupled to a first word line of the multiple word lines, 1≤i≤R; and the fourth set of pages may include, from each subset of pages, an i^{th} page coupled to a third word line that can be non-adjacent to the first word line.

In some implementations, the processor may be further configured to perform an encoding operation on the data portions to generate the J parity data portions.

In some implementations, the processor may be further configured to: control the I/F circuit to receive a first data portion corresponding to a first page of the subset of pages, and a second data portion corresponding to a second page of the subset of pages; and perform an XOR operation on the first data portion and the second data portion.

In some implementations, one stripe of the J stripes may correspond to one parity data portion of the J parity data portions. The processor may be further configured to: generate the write command; and control the I/F circuit to send the write command and the parity data portion to the memory device to store the parity data portion in a last page of the stripe.

In some implementations, the processor may be further configured to, in response to a read failure associated with a third data portion: locate the third data portion, corresponding to the read failure, in the memory device; obtain remaining data portions and a first parity data portion in a stripe with the third data portion; generate a reconstructed data portion based on the first parity data portion and the remaining data portions; and control the I/F circuit to send the reconstructed data portion to the memory device to store the reconstructed data portion in the memory device.

In some implementations, the processor may be further configured to generate the J parity data portions in parallel.

In some aspects, a method for Redundant Device of Independent Disks (RAID) striping is provided. The method can be implemented in a memory device that includes one or more dies each including a plurality of planes. Each of the plurality of planes may include a subset of pages, corresponding to multiple word lines, to form a striping group in the one or more dies. One word line of the multiple word lines may be coupled to R strings in each plane to form R pages. The striping group may form J stripes. Each of R and J can be an integer, and a ratio of J to R can be a value greater than 1 and less than 2. The method may include receiving data portions corresponding to the J stripes; generating J parity data portions based on the data portions; and controlling the memory device to store the J parity data portions.

In some implementations, the ratio of J to R can be equal to 1.5.

In some implementations, the ratio of J to R can be equal to 1.25.

In some implementations, the ratio of J to R can be equal to 1.75.

In some implementations, the method may further include according to a programming failure distribution associated with the memory device, determining the ratio of J to R.

In some implementations, in the subset of pages, two i^{th} pages of a same string, coupled to two adjacent word lines of the multiple word lines, may belong to two stripes of the J stripes, 1≤i≤R.

In some implementations, in the subset of pages, two adjacent pages, coupled to a same word line of the multiple word lines, may belong to two stripes of the J stripes.

In some implementations, in the subset of pages, each of a first page, a second page, and a third page, coupled to a same word line, may belong to a respective stripe of the J stripes. The second page and the third page may be adjacent to the first page corresponding to the same word line.

In some implementations, in the subset of pages, each of a fourth page, a fifth page, and a sixth page, respectively coupled to a first word line, a second word line, and a third word line, may belong to a respective stripe of the J stripes. The first word line and third word line may be adjacent to the second word line. The fourth, fifth, and sixth pages may correspond to a same string.

In some implementations, a first stripe of the J stripes may include a first set of pages and a second set of pages. The first set of pages may include, from each subset of pages, an i^{th} page coupled to a first word line of the multiple word lines, 1≤i≤R; and the second set of pages may include, from each subset of pages, a j^{th} page coupled to a second word line adjacent to the first word line, 1≤j≤R, and ji.

In some implementations, a first stripe of the J stripes may include a third set of pages and a fourth set of pages. The third set of pages may include, from each subset of pages, an i^{th} page coupled to a first word line of the multiple word lines, 1≤i≤R; and the fourth set of pages may include, from each subset of pages, an i^{th} page coupled to a third word line that is non-adjacent to the first word line.

In some implementations, generating the J parity data portions based on the data portions may include performing an encoding operation on the data portions to generate the J parity data portions.

In some implementations, generating the J parity data portions based on the data portions may include receiving a first data portion corresponding to a first page of the subset of pages, and a second data portion corresponding to a second page of the subset of pages; and performing an XOR operation on the first data portion and the second data portion.

In some implementations, one stripe of the J stripes may correspond to one parity data portion of the J parity data portions; and controlling the memory device to store the J parity data portions may include controlling the memory device to store the parity data portion in a last page of the stripe.

In some implementations, the method may further include in response to a read failure associated with a third data portion: locating the third data portion, corresponding to the read failure, in the memory device; obtaining remaining data portions and a first parity data portion in a stripe with the third data portion; generating a reconstructed data portion based on the first parity data portion and the remaining data portions; and replacing the third data portion with the reconstruction data portion.

In some implementations, generating the reconstructed data portion may include performing XOR operations on the remaining data portions and the first parity data portion to generate the reconstructed data portion.

In some implementations, the method may further include when no read failure is associated with the J stripes, sending a notification signal to a host.

In some aspects, a non-transitory storage medium coupled with a memory device and a processor is provided. The memory device may include one or more dies each including a plurality of planes. Each of the plurality of planes may include a subset of pages, corresponding to multiple word lines, to form a striping group in the one or more dies. One word line of the multiple word lines may be coupled to R strings in each plane to form R pages. The striping group may form J stripes. Each of R and J can be an integer, and a ratio of J to R can be a value greater than 1 and less than 2. The non-transitory storage medium can be configured to store instructions that, when executed by the processor, may cause the processor to: receive data portions corresponding to the J stripes; generate J parity data portions based on the data portions; and control the memory device to store the J parity data portions.

### BRIEF DESCRIPTION OF THE DRAWINGS

The accompanying drawings, which are incorporated herein and form part of the specification, illustrate some implementations of the present disclosure and, together with the description, further serve to explain the principles of the present disclosure and to enable a person skilled in the pertinent art to make and use the present disclosure.

FIG. 1A illustrates a schematic diagram showing an example hierarchy of a memory device, according to some aspects of the present disclosure.

FIG. 1B illustrates a circuit diagram of an example memory device including peripheral circuits, according to some aspects of the present disclosure.

FIG. 1C illustrates a schematic diagram of an example physical structure of a memory cell array, according to some aspects of the present disclosure.

FIG. 2A illustrates a schematic diagram of an example data structure and striping configuration for a RAID algorithm implemented in a memory device, according to some aspects of the present disclosure.

FIG. 2B illustrates a schematic diagram showing multiple memory strings in two memory blocks, according to some aspects of the present disclosure.

FIG. 2C illustrates a schematic diagram of the example striping configuration of FIG. 2A from another perspective, according to some aspects of the present disclosure.

FIG. 3A illustrates a schematic diagram of another example data structure and striping configuration for a RAID algorithm implemented in a memory device, according to some aspects of the present disclosure.

FIG. 3B illustrates a schematic diagram of the example striping configuration of FIG. 3A from another perspective, according to some aspects of the present disclosure.

FIG. 4A illustrates a schematic diagram of an example system where a non-integer striping configuration is implemented, according to some aspects of the present disclosure.

FIG. 4B illustrates a diagram of an example memory card having a memory device, according to some aspects of the present disclosure.

FIG. 4C illustrates a diagram of an example solid-state drive (SSD) having a memory device, according to some aspects of the present disclosure.

FIG. 5A illustrates a schematic diagram of an example memory controller in collaboration with a host and a memory device for RAID processes, according to some aspects of the present disclosure.

FIG. 5B illustrates a schematic diagram of an example memory device including a memory cell array and peripheral circuits, according to some aspects of the present disclosure.

FIG. 6A illustrates a schematic diagram of a first example data structure and non-integer striping configuration for a RAID algorithm implemented in a memory device, according to some aspects of the present disclosure.

FIG. 6B illustrates a schematic diagram of the first example striping configuration of FIG. 6A from another perspective, according to some aspects of the present disclosure.

FIG. 7 illustrates a flowchart of an example method for operating a memory device, according to some aspects of the present disclosure.

FIG. 8 illustrates a bar diagram showing a programming failure distribution among different strings in a memory device, according to some aspects of the present disclosure.

FIGS. 9A and 9B illustrate flowcharts of example methods for determining stripes, according to some aspects of the present disclosure.

FIG. 10 illustrates a schematic diagram of a second example data structure and non-integer striping configuration for a RAID algorithm implemented in a memory device, according to some aspects of the present disclosure.

FIG. 11 illustrates a schematic diagram of a third example data structure and non-integer striping configuration for a RAID algorithm implemented in a memory device, according to some aspects of the present disclosure.

FIG. 12 illustrates a schematic diagram of a fourth example data structure and non-integer striping configuration for a RAID algorithm implemented in a memory device, according to some aspects of the present disclosure.

FIG. 13 illustrates a schematic diagram of a fifth example data structure and non-integer striping configuration for a RAID algorithm implemented in a memory device, according to some aspects of the present disclosure.

FIG. 14A illustrates a schematic diagram of a sixth example data structure and non-integer striping configuration for a RAID algorithm implemented in a memory device, according to some aspects of the present disclosure.

FIG. 14B illustrates a schematic diagram of the sixth example striping configuration of FIG. 14A from another perspective, according to some aspects of the present disclosure.

FIG. 15 illustrates a schematic diagram of a seventh example data structure and non-integer striping configuration for a RAID algorithm implemented in a memory device, according to some aspects of the present disclosure.

FIG. 16 illustrates a schematic diagram of a data recovery protection of an example non-integer striping configuration, according to some aspects of the present disclosure.

Some implementations of the present disclosure will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “some implementations,” “exemplary implementations,” “other implementations,” “some examples,” etc., indicate that the implementation described may include a particular feature, structure, or characteristic, but every implementation may not necessarily include the particular feature, structure, or characteristic. Moreover, such phrases do not necessarily refer to the same implementation. Further, when a particular feature, structure, or characteristic is described in connection with an implementation, it would be within the knowledge of a person skilled in the pertinent art to effect such feature, structure, or characteristic in connection with other implementations whether or not explicitly described.

In general, terminology may be understood at least in part from usage in context. For instance, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the terms “based on” and “according to” may be understood as not necessarily intended to convey an exclusive set of factors and may, instead, allow for the existence of additional factors not necessarily expressly described, again, depending at least in part on context.

As used herein, the terms “nominal/nominally” and “substantial/substantially” refer to a desired, or target, value of a characteristic or parameter for a component or a process operation, set during the design phase of a product or a process, together with a range of values above and/or below the desired value. The range of values can be due to slight variations in manufacturing processes or tolerances. As used herein, the terms “about” and “approximately” indicate the value of a given quantity that can vary based on a particular technology node associated with the subject semiconductor device. Based on the particular technology node, the terms “about” and “approximately” can indicate a value of a given quantity that varies within, for example, 10-30% of the value (e.g., ±10%, ±20%, or ±30% of the value).

As used herein, the term “three-dimensional (3D) memory device” refers to a semiconductor device that incorporates vertically oriented strings of memory cells on a laterally-oriented substrate, where connection strings extend in the vertical direction with respect to the substrate. The term “connection string” refers to a vertically-oriented and serial connection of memory cells on a laterally-oriented substrate so that the connection string of memory cells extends in the vertical direction with respect to the substrate. Additionally, the term “vertical/vertically” refers to a direction that is perpendicular to the lateral plane of the substrate.

To increase storage capacity, a memory device often includes multiple dies, each having multiple planes. In some instances, each plane can be divided into one or more memory blocks, and each block may include multiple gate conductive layers extending laterally. The gate conductive layers may be arranged vertically in several levels, and each gate conductive layer may be coupled to memory cells in multiple pages that are laterally distributed in the memory block.

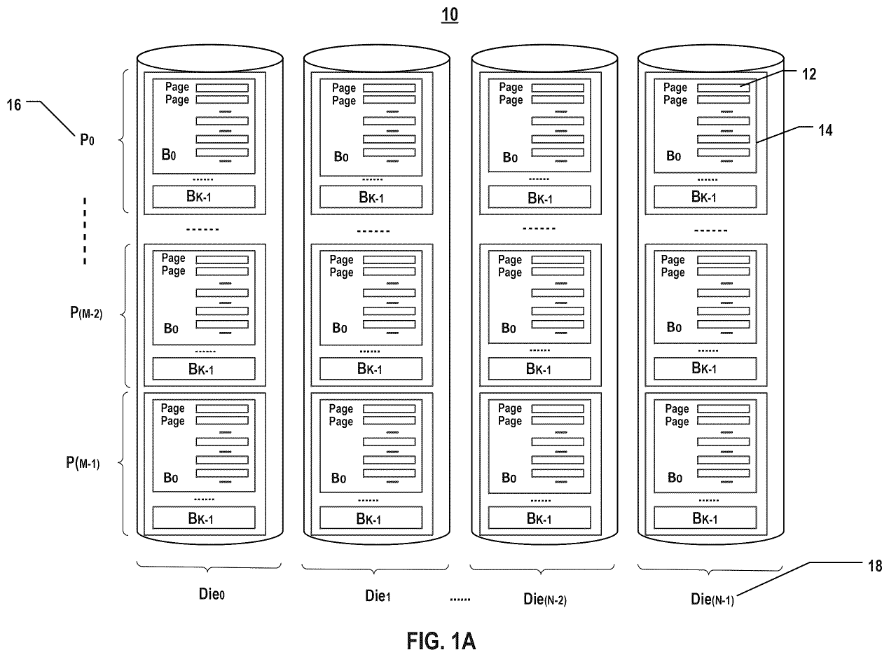

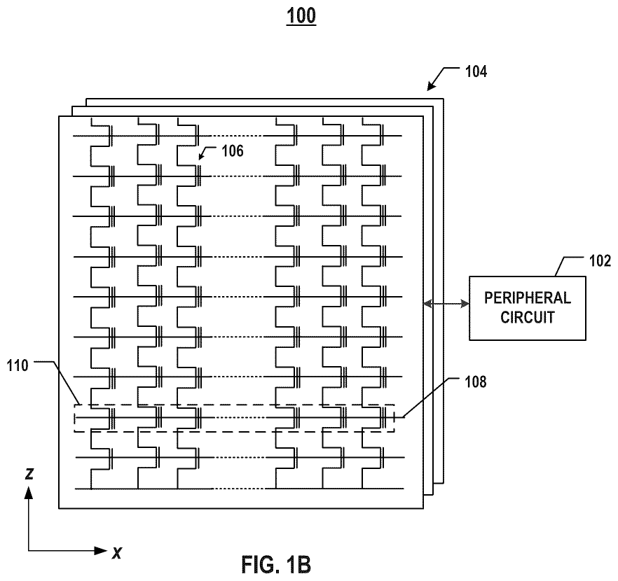

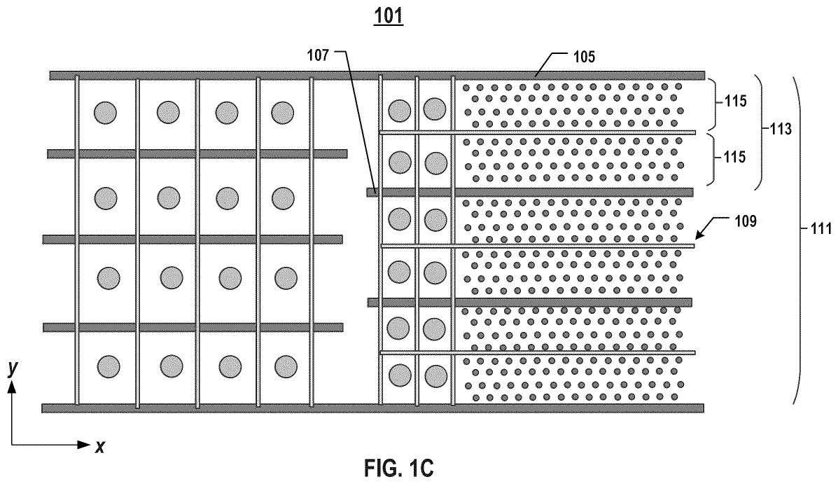

FIG. 1A illustrates a schematic diagram showing an example hierarchy of a memory device 10, according to some aspects of the present disclosure. In some instances, memory device 10 can be a NAND memory device of a three-dimensional structure. NAND memory cells in NAND memory device 10 can be organized into pages 12 (e.g., physical pages), which are further grouped into multiple memory blocks 14 (e.g., K memory blocks from B₀ to Bₖ₋₁), as shown in FIG. 1A. Each NAND memory cell can be electrically connected to a corresponding bit line (BL) that extends in the third direction (i.e., the z-direction in FIG. 1A, or a bit-line direction). Memory cells that are at the same physical level in NAND memory device 10 can be electrically connected through their respective control gates by a word line WL (i.e., a corresponding conductive gate layer). Each word line may be electrically coupled to the memory cells across multiple pages 12.

In some implementations, a certain number of memory blocks 14 can be further grouped into one plane 16. Hence, NAND memory device 10 can include multiple planes 16 (e.g., M planes from P₀ to P_{M-1} in each die), as shown in FIG. 1A. A plane 16 can be an independent storage unit within NAND memory device 10, responsible for storing and managing data. Each plane 16 can include one or more memory blocks 14 and can independently perform read, write, and erase operations. By executing these operations simultaneously across multiple planes 16, NAND memory device 10 with multiple planes 16 can significantly improve its performance, particularly by reducing latency and increasing data throughput through parallel processing.

Each gate conductive layer (corresponding to one word line at the circuit level) can extend laterally in the first direction (i.e., the x-direction in FIG. 1A, or a bit-line direction). In a memory block 14, memory cells connected by a single gate conductive layer form one page 12. A single memory block 14 can include multiple pages 12 connected by multiple word lines. In some implementations, NAND memory device 10 may further include multiple dies 18 (e.g., N dies from Die₀ to Die_{N-1}), each including one or more planes 16, as shown in FIG. 1A. Dividing memory cells into multiple planes 16 can allow a memory controller to perform parallel accesses, enabling simultaneous operations across different planes and enhancing overall data access speed. Additionally, distributing data across multiple planes can also optimize erase operations and lifespan management, as wear leveling can be applied.

FIG. 1B illustrates a circuit diagram of an example memory device 100 including peripheral circuits 102, according to some aspects of the present disclosure. Memory device 100 may include a memory cell array 104 and peripheral circuits 102 coupled to memory cell array 104. Memory device 100 can be an example of memory device 10. In some implementations, memory cell array 104 can be a NAND flash memory cell array that includes NAND memory cells 106, in a memory block, arranged in rows and columns. Memory cells 106 in a column of memory cell array 104 can be stacked vertically (in the z-direction) and coupled in series. Memory cells 106 in a row of the memory cell array 104 can be coupled to and controlled by a word line 108. Each memory cell 106 can hold a continuous, analog value, such as an electrical voltage or charge that depends on the number of electrons trapped within memory cell 106. The logic state (i.e., data) of each memory cell 106 can be determined based on the threshold voltage Vth of memory cell 106. Each memory cell 106 can be a floating gate type memory cell including a floating-gate transistor, or a charge trap type memory cell including a charge-trap transistor.

In some implementations, each memory cell 106 can be a single-level cell (SLC) with two possible memory states that can store one bit of data. For instance, the first memory state “1” (e.g., erased state) can correspond to the first range of voltages, and the second memory state “0” (e.g., programmed state) can correspond to the second range of voltages. The first range of voltages and the second range of voltages may not overlap. In some implementations, to increase storage capacity, each memory cell 106 can be a multi-level cell (MLC), a triple-level cell (TLC), or a quad-level cell (QLC). An MLC can store two bits of data, and include four logic states, {11, 10, 01, and 00} (i.e., fully erased state, and programmed states P1, P2, and P3). A TLC can store three bits of data, and include eight logic states, {111, 110, 101, 100, 011, 010, 001, 000} (i.e., fully erased state, and programmed states P1-P7). A QLC can store 4 bits of data and include 16 logic states, {1111, 1110, 1101, 1100, 1011, 1010, 1001, 1000, 0111, 0110, 0101, 0100, 0011, 0010, 0001, 0000 (i.e., fully erased state and programmed states P1-P15).

In some implementations, memory cell 106 can be an SLC, and each word line 108 is coupled to one or more physical pages 110 of memory cells 106. One physical page is the basic data unit for program operations. The size of one physical page 110 is associated with the number of columns of memory cells 106 coupled with one word line 108 in a memory block. One physical page 110 can be associated with one or more logic pages based on the number of bits that a memory cell 106 can store. For instance, when memory cell 106 is an SLC that can store one bit of data, one physical page 110 can be associated with one logic page. When memory cell 106 is an MLC that can store two bits of data, one physical page 110 can be associated with two logic pages. When memory cell 106 is a TLC that can store three bits of data, one physical page 110 can be associated with three logic pages (i.e., a lower page, a middle page, and an upper page). When memory cell 106 is a QLC that can store four bits of data, one physical page 110 can be associated with four logic pages. Logic pages associated with the same physical pages 110 can share the same physical addresses.

In some implementations, peripheral circuits 102 can be coupled with memory cell array 104 through bit lines, word lines, and source lines. Memory cells 106 in a column of memory cell array 104 can be coupled to a source select gate (SSG) transistor at a source end, and a drain select gate (DSG) transistor at a drain end. The SSG transistor and the DSG transistor can be configured to activate the column of memory cell array 104 when it is selected during read and program operations.

FIG. 1C illustrates a schematic diagram of an example physical structure of a memory cell array 101, according to some aspects of the present disclosure. Memory cell array 101 can be an example of memory cell array 104 in FIG. 1B. As shown in FIG. 1C, memory cell array 101 can include multiple rows of memory cells separated by parallel gate isolation structures extending in the x-direction (e.g., first gate isolation structures 105, second gate isolation structures 107, and third gate isolation structures 109), as shown in FIG. 1C. In some implementations, first gate isolation structures 105 can be configured to organize memory cell array 101 into multiple memory blocks 111, and second gate isolation structures 107 can further divide one memory block into multiple memory fingers 113. One memory finger 113 can be further divided into multiple memory strings 115 by third gate isolation structures 109 (e.g., top select gate isolation structures). In some implementations, third gate isolation structure 109 that serves as a top select gate isolation structure may have a configuration different from first gate isolation structures 105 and second gate isolation structures 107. For instance, in some examples, first gate isolation structures 105 and 107 may extend through an entire memory stack of memory cell array 101 to divide the memory stack into different regions, while third gate isolation structures 109 may cut through, e.g., a top select gate layer, without penetrating the entire memory stack for controlling different portions of memory cells through divided top select gate layers.

The memory cells in a memory string 115 coupled to the same word line can be referred to as one “page,” typically referring to one physical page. In some implementations, one memory block 111 can include a plurality of memory strings 115, as shown in FIG. 1C. In some implementations, the SSG transistors of memory strings 115 in the same memory finger 113 can be coupled to the same SSG line.

In the present disclosure, the terms “a word line coupled to a memory string” and “one page,” on certain levels, may represent similar concepts, as both of the terms may refer to a set of memory cells that are connected/controlled by the same word line. While “a word line coupled to a memory string” typically denotes, at the semiconductor level, a physical subset of memory cells coupled to the same word line within a memory block, “memory page” can represent an access unit, at the circuit level, including all memory cells along a specific word line. Accordingly, both of the terms may broadly signify a group of memory cells connected/controlled by a single word line.

To improve the data integrity of the memory cells, RAID algorithms are widely applied in NAND Flash memory. RAID algorithms of different levels typically employ various striping techniques across memory pages or blocks to divide data into multiple data portions, perform encoding operations on the data portions to generate corresponding parity information, and store the parity information for subsequent data recovery when necessary. In the striping approaches, a data portion in one stripe can represent data to be stored in a single page, and one stripe can include data portions arranged in two dimensions: laterally across different memory blocks, planes, and dies, and vertically across multiple levels (word lines) within the same memory blocks.

In some implementations, certain RAID algorithms (such as RAID 4 or RAID 5) can be applied to UFS (Universal Flash Storage) and SSD (Solid State Drive) products to recover data portions within stripes. These RAID algorithms can provide block-level data striping across multiple planes and dies to ensure data redundancy. For that purpose, they can be configured to output and store parity information (i.e., redundant data used for recovery) which is generated as the encoding operation result of the pages as striped. In some instances, the parity information may require a portion of the space that is reserved for storage (i.e., Over-provisioning, OP). Additionally, a certain amount of a swap buffer (or termed “RAID buffer”) may also be required. The terms “swap buffer” and “RAID buffer” are used to refer to storage for caching the redundant data (e.g., the parity data) generated during program operations from data. In the event of a read failure, the stored parity information can be used to reconstruct a faulty data portion, ensuring data integrity and fault tolerance.

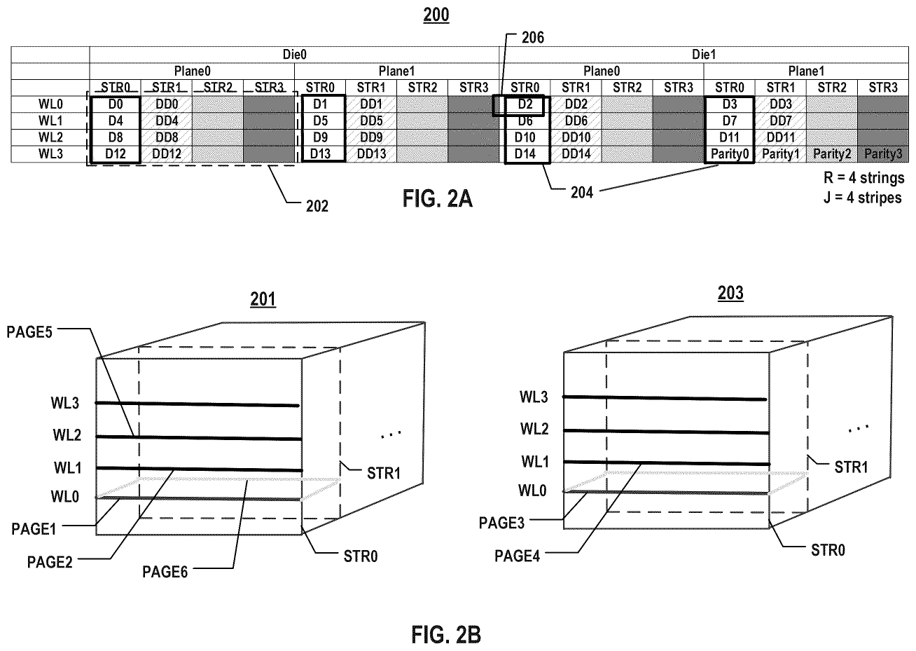

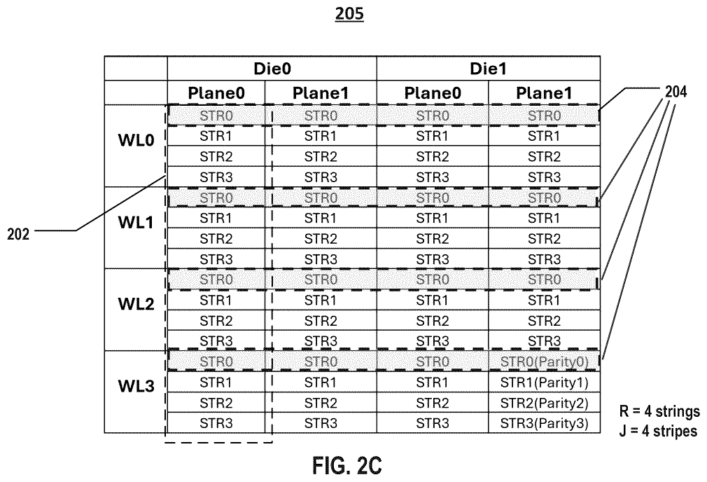

FIG. 2A illustrates a schematic diagram of an example data structure and striping configuration for a RAID algorithm implemented in a memory device 200, according to some aspects of the present disclosure. In some instances, memory device 200 can be a NAND memory device, such as memory device 100 in FIG. 1B. For ease of illustration, NAND memory device 200 in FIG. 2A is represented in a tabular format. Additionally, NAND memory device 200 is simplified to illustrate two planes of a die and four memory strings per plane. In this example, data is to be stored in two die (“Die0” and “Die1”) each having two planes (“Plane0” and “Plane1”). Each plane can include one or more memory blocks configured to store data. Memory device 200 in FIG. 2A can correspond to four word lines arranged vertically (“WL0” to “WL3”). Each word line, in one plane, can be coupled to 4 memory strings (“STR0,” “STR1,” “STR2,” and “STR3”) to form four pages.

In some implementations, a memory device may have more than two dies, and each die may have more than two planes. Each memory block can include more than four word lines, and each word line can be coupled to more than four pages in one plane. Therefore, it can be understood that FIG. 2A can depict part or the entirety of the data to be stored in memory device 200. In other words, FIG. 2A may depict one striping group only. Additionally, FIG. 2A may show an example striping configuration where the SLC technology is implemented. It is apparent that the striping configuration in FIG. 2A can also be applied to the MLCs, the TLCs, or the QLCs. For instance, when the TLC technology is applied, each physical page can correspond to three logic pages for storing upper page (UP) data portions, middle page (MP) data portions, and lower page (LP) data portions.

In the striping configuration depicted in FIG. 2A, a stripe 204 (shown in larger bold boxes) can include multiple pages 206 (shown in a smaller bold box) across different planes of each die. More specifically, to form stripe 204 according to this striping configuration, pages 206 that correspond to a string having the same index (e.g., “STR0”-String 0) in a subset of pages 202 of each plane can be striped. Laterally, stripe 204 can include data portions, across different planes of each die, located at the same section (i.e., the i^{th} page corresponding to each word line). Vertically, stripe 204 can include data portions at different levels (i.e., pages corresponding to different word lines). In FIG. 2A, to maintain the clarity of the illustration, the indicator is only connected to a portion of the stripe.

In the present disclosure, the terms “pages located at the same section” and “pages of a same string” are used to refer to the pages corresponding to a string having the same index in a striping group. To explain the terms “pages located in the same section” and “a same string,” FIG. 2B is provided and referred to. FIG. 2B illustrates a schematic diagram showing multiple memory strings in memory blocks 201 and 203, according to some aspects of the present disclosure. Memory blocks 201 and 203 may belong to different planes. As shown in FIG. 2B, strings of memory block 201 may include STR0, STR1, and others, as in memory block 203. PAGE1 and PAGE2 in memory block 201 can correspond to the same string (i.e., STR0), although PAGE1 is coupled to word line WL0, and PAGE2 is coupled to word line WL1. In another example, PAGE1 and PAGE4 also correspond to the same string (i.e., STR0), although these pages are in different planes. As a result, PAGE1, PAGE2, PAGE3, and PAGE4 are located in the same section. In other words, in the present disclosure, the term “same string” may refer to pages corresponding to a string having the same index/located in the same section, either in the same plane or different planes.

In some implementations, a parity data portion for stripe 204 shown in FIG. 2A can be derived from an encoding operation. In some implementations, a series of XOR operations can be performed on the data to be stored in stripe 204. For instance, for data portions D0, D1, . . . , and D14 to be stored in 15 pages of stripe 204, the parity data Parity0 can be generated by:

$$Parity 0 = ( D 0 ) XOR ( D 1 ) XOR ( D 2 ) … XOR ( D 14 ) . \qquad ( 1 )$$

In some implementations, the XOR operations for generating the parity data portion according to Equation (1) can be performed sequentially. For instance, upon the receipt of data portions D0 and D1, the result of an XOR operation on data portions D0 and D1 can be obtained. Subsequently, upon the receipt of data portion D2, another XOR operation can be performed on data portion D2 and the result of the XOR operation.

In some implementations, the parity data can be stored in a page of stripe 204 per se, e.g., the last page of stripe 204 (corresponding to Parity0 in FIG. 2A). In some implementations, the parity data can be stored in a dedicated memory block instead of in the stripe, to which the present disclosure does not limit. In the example of FIG. 2A, 15 data portions (e.g., from D0 to D14) are utilized employing XOR operations to generate one parity data portion (e.g., Parity0), resulting in the data-to-parity ratio of 15:1. This ratio can represent the space occupied by the data portions to that by the parity data portion.

For a striping group with this striping configuration, four stripes each corresponding to one parity data portion can be generated. When a parameter J is used to represent the number of stripes generated, J becomes 4. When another parameter R is used to represent the number of strings a word line is coupled in a plane, in this example, R is also equal to 4. It results in both J and R equal to 4. The four parity data portions produced can be stored in four pages (e.g., in Plane 1 of Die 1 as shown in FIG. 2A). In some implementations, the parity data portions may require temporary storage in the RAID buffer before being written to the corresponding memory locations (e.g., the last four pages of the four stripes), which can also occupy the space of four physical pages in the RAID buffer.

FIG. 2C illustrates a schematic diagram of the exemplary striping configuration of FIG. 2A from another perspective 205, according to some aspects of the present disclosure. Subset of pages 202 and stripe 204 in FIG. 2A are illustrated in a different perspective in FIG. 2C.

This striping configuration of FIGS. 2A and 2C can be termed “1-WL RAID protection.” The produced four parity data portions are stored in four pages, e.g., all coupled to one word line. From FIG. 2B, it can be understood that, in this striping strategy, data portions to be stored in pages corresponding to the same sections participate in the XOR operations for generating one stripe. In the event of a read failure associated with one data portion of the stripe (e.g., D0), recovery can be achieved by performing a decoding operation using the parity data portion (e.g., Parity0) and the remaining data portions (e.g., from D1 to D14). For instance, with reference to FIG. 2A, when the read operation of data portion D0 fails, it can be recovered by:

$$( D 0 ) = Parity 0 XOR ( D 1 ) XOR ( D 2 ) … XOR ( D 14 ) . \qquad ( 2 )$$

Similarly, for the second stripe (shown in diagonal-striped textures) in FIG. 2A, the parity data Parity1 can be generated by performing another encoding operation using data portions DD0 to DD14. As described, 1-WL RAID protection may have the advantage of efficient storage. That is, a relatively small RAID buffer is required and utilized to store the parity data before being written to the corresponding stripes. It may have a more efficient use of memory space, as this striping configuration minimizes the need for a large space for the storage of the parity data.

On the other hand, while the parity data can protect against the failure of a single data portion, it can fail to protect against multiple simultaneous failures within the same stripe, thereby leading to a potential data loss. For instance, when two data portions in the same stripe both fail, it becomes impossible to recover even using the parity data and the remaining data portions in a decoding operation. One scenario that can cause more than one faulty data portion in the same stripe can be a “multi-plane failure,” which can result from programming errors when multiple planes are being programmed in parallel. Data portions located at the same section in different planes (e.g., Data D0 to be stored in PAGE1 and Data D1 to be stored in PAGE3 of FIG. 2B both fail), can fail simultaneously. In another scenario, more than one faulty data portion in one stripe can be caused by a “source-select gate (SSG) leakage failure” (i.e., a current leakage of SSG). The SSG leakage failure can result in faulty data portions coupled with the same SSG, e.g., located at the same section of the same plane at different levels (e.g., Data D0 to be stored in PAGE1 and Data D4 to be stored in PAGE2 of FIG. 2B both fail).

In the present disclosure, the terms “faulty data portion” and “failed data portion” are used to refer to a data portion in a memory device that cannot be accessed or read correctly due to errors or failures. The faulty data portions may result from various causes, such as physical defects in the memory cells and/or programming errors. In some instances, these terms may refer to not only corrupted or inaccessible data but also missing data, where the data was either never properly written or has been entirely lost due to failures.

It was noticed that the interference between two adjacent word lines within a block could be quite significant. When a position experiences a failure, generally, it can affect the validity of the data in adjacent word lines (e.g., a word-line and word-line short failure). To address this issue, the present application proposes another striping configuration, termed “2-WL striping protection.” The term “2-WL striping” is used to refer to the placement of two pages located at the same section of the same plane, coupled to two adjacent word lines, in different stripes. As such, when a page and another page coupled with two adjacent word lines both experience failures, recovery can be achieved through multiple RAID stripes.

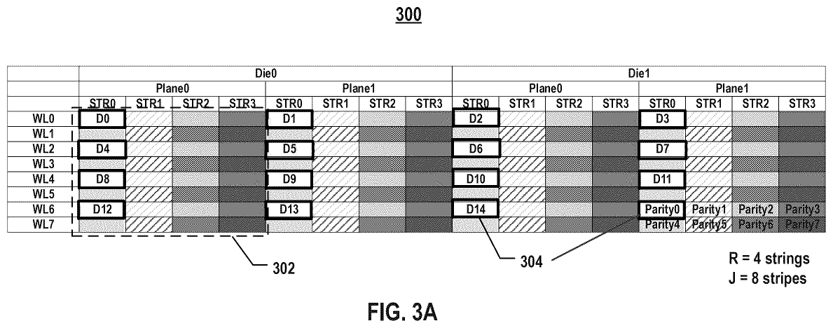

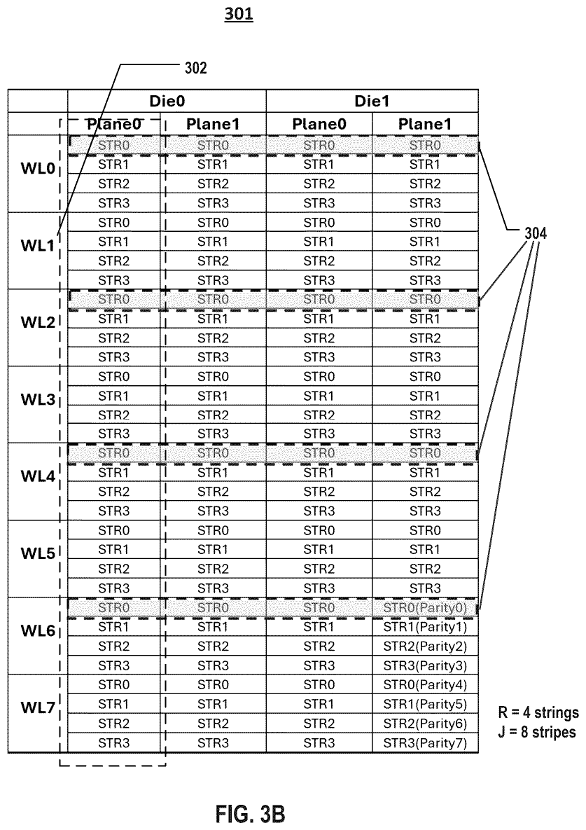

FIG. 3A illustrates a schematic diagram of another example data structure and striping configuration for a RAID algorithm implemented in a memory device 300, according to some aspects of the present disclosure. In some instances, memory device 300 can be a NAND memory device, such as memory device 100 in FIG. 1B. For ease of illustration, NAND memory device 300 in FIG. 3A can also be represented in a tabular format. Additionally, NAND memory device 300 is simplified to illustrate two planes of a die and four memory strings per plane. In this example, data is to be stored in two die (“Die0” and “Die1”) each having two planes (“Plane0” and “Plane1”). Each plane can include one or more memory blocks configured to store the data. In FIG. 3A, a subset of pages 302 in one plane is illustrated, which can represent pages to be striped in a striping group of this plane. Subset of pages 302 can correspond to eight word lines (“WL0” to “WL7”) arranged vertically. In this example, each plane in memory device 300 corresponds to four memory strings (“STR0,” “STR1,” “STR2,” and “STR3”), and thus each word line can be coupled to four pages. Therefore, associated with FIG. 3A, R is equal to 4.

As shown in FIG. 3A, 2-WL striping protection can place the data portions to be stored in pages of two adjacent word lines in different stripes 304. More specifically, in this striping configuration, laterally, stripe 304 can include data portions located at the same section across different planes (e.g., Data D0 to be stored in PAGE1 and Data D1 to be stored in PAGE3 of FIG. 2B). Vertically, stripe 304 can include data portions located at the same section of the same plane and corresponding to two non-adjacent word lines (e.g., Data D0 to be stored in PAGE1 and Data D4 to be stored in PAGE5 of FIG. 2B). In FIG. 3A, to maintain the clarity of the illustration, the indicator is only connected to a portion of this stripe.

As shown in FIG. 3A, one stripe 304 may include data portions D0, D1, . . . , and D14, thus bringing that parity data Parity0 can be derived by performing a series of XOR operations on data portions D0, D1, . . . , and D14. In some implementations, parity data Parity0 can be stored in stripe 304 as shown in FIG. 3A, although in some implementations, the parity data can be stored in other memory locations, such as a dedicated memory block. Similarly, for another stripe in FIG. 3A, parity data Parity1 can be produced by performing a series of XOR operations using corresponding data portions. Consequently, eight stripes can be produced based on subsets of pages 302 in this striping group, resulting in J equal to 8. In the event of a read failure associated with one data portion of the stripe (e.g., D0 in first stripe 304), recovery can be achieved by performing XOR operations using the parity data (e.g., Parity0) and the remaining data portions (e.g., from D1 to D14).

FIG. 3B illustrates a schematic diagram of the example striping configuration of FIG. 3A from another perspective 301, according to some aspects of the present disclosure. Subset of pages 302 and stripe 304 in FIG. 3A are illustrated in a different perspective in FIG. 3B.

By arranging two pages, coupled to adjacent word lines, in different stripes, 2-WL striping configuration can provide a higher level of data protection against various failures compared to the 1-WL striping configuration. For instance, 2-WL striping configuration can be used to recover certain NAND failure types that cannot be addressed in 1-WL striping configuration, such as a word-line and word-line short failure (i.e., programming failures of two adjacent word lines in the same block/plane). On the other hand, as more data needs to be temporarily buffered and managed, 2-WL striping configuration can require a larger RAID buffer, leading to higher memory overhead. Upon a request for recovery, the parity data may need to be read from a memory device and buffered in the RAID buffer for XOR recovery calculation, leading to frequency data swaps and higher memory overhead.

More specifically, according to the example depicted in FIG. 3A, to maintain the same data-to-parity ratio of 15:1 as in FIG. 2A, eight stripes each corresponding to one parity data portion (“Parity0” to “Parity7”) may be generated. That is, J is equal to 8. The eight parity data portions can be stored in corresponding eight pages, either in the stripes or in other memory locations. In subset of pages 302 of FIG. 3A, each word line can be coupled to four pages. Consequently, the eight parity data portions can occupy eight pages coupled to two word lines (e.g., “WL6” and “WL7” in Plane1 of Die1 as shown in FIG. 3A). This is double the size of 1-WL striping protection. This increased resource requirement can lead to higher RAID buffer usage and longer latency during data transactions due to the requirements for managing and swapping data.

As the number of layers in NAND technology increases, the likelihood of failures among word lines may also rise. The data protection of 1-WL RAID striping configuration is relatively weak, thus posing a challenge to data integrity. However, when the buffer size of a memory controller is restricted, the implementation of 2-WL RAID protection can also become challenging.

In view of these striping configurations, alternative striping configurations that can offer robust protection for data integrity by generating a significant amount of parity data are being researched. In particular, the increased level of redundancy can provide a higher degree of fault tolerance, ensuring that the system can recover data in the event of failures. However, these configurations also come with a trade-off, particularly when the larger volume of parity data generated can require a substantial OP space. As a result, while these configurations are highly effective in enhancing reliability, they are not always candidates for systems with limited memory resources.

To address one or more aforementioned issues, the present disclosure introduces solutions in which non-integer RAID striping configurations are implemented to recover failures. The approaches balance robust data protection with minimal impact on performance and cost. In particular, current NAND technology faces challenges with word-line leakage that causes leakage currents to occur between two adjacent word lines in a NAND memory device. Word-line leakage can be a significant concern in NAND technology, and addressing it becomes crucial for maintaining data integrity and extending the lifespan of a memory device.

According to some implementations of the present disclosure, based on Defective Parts Per Million (DPPM) distribution, protection strategies with reasonable cost may be adopted while reducing the impact on performance. Accordingly, striping based on integer multiples of word lines may not be necessary. The striping configurations may be customized according to actual requirements. In accordance with some implementations of the present disclosure, non-integer striping configurations that cover most of word-line leakage issues are proposed. The non-integer striping configurations can provide coverage of most DPPM issues with relatively reasonable usage of RAID buffer while reducing the buffer occupancy on the performance aspects.

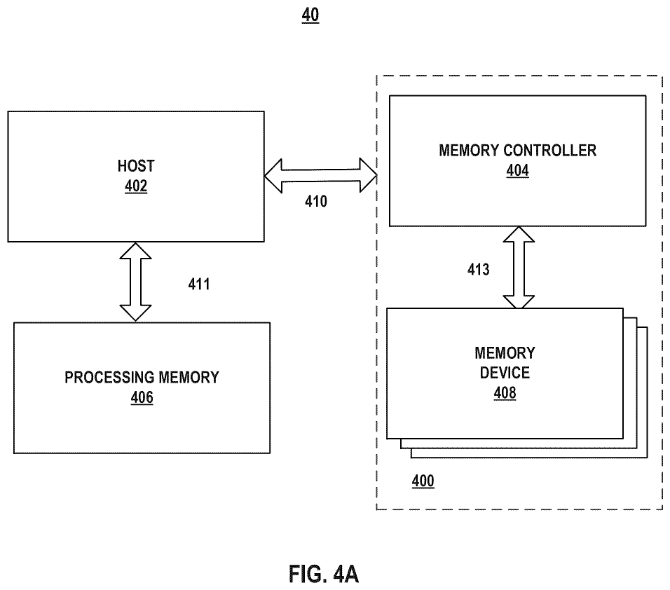

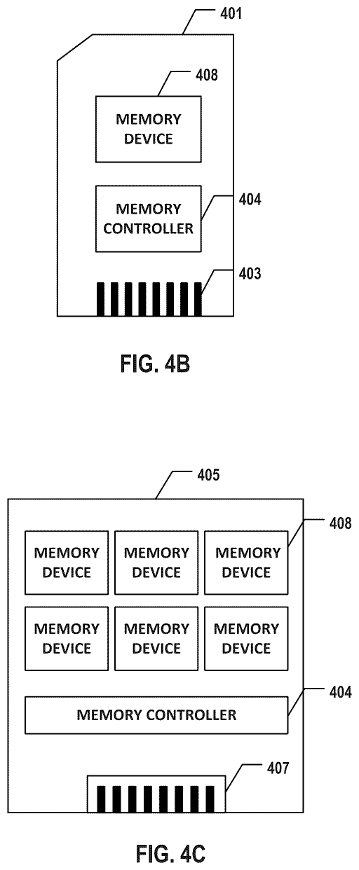

FIG. 4A illustrates a schematic diagram of an example system 40 where a non-integer striping configuration is implemented, according to some aspects of the present disclosure. System 40 can include a memory system 400 or a system including a memory device. As shown in FIG. 4A, system 40 may include a host 402, a memory controller 404, a processing memory 406, and a memory device 408. In some implementations, memory system 400 can include memory controller 404 and memory device 408.

It can be understood that system 40 may include any other suitable components. For ease of illustration, these components are omitted from FIG. 4A. In some instances, host 402, memory controller 404, processing memory 406, and memory device 408 can be arranged on a printed circuit board (PCB). In some implementations, each of host 402, memory controller 404, processing memory 406, and memory device 408 can be designed and implemented as a discrete chip with its packaging and mounted on the PCB. In some instances, memory controller 404, processing memory 406, and memory device 408 can be implemented into the same chip (e.g., a UFS/SSD), host 402 can be an external device to the chip, to which the present disclosure is not limited.

Host 402 can include a specialized processor for performing data processing of memory device 408. For example, host 402 may include a central processing unit (CPU) and/or a system-on-chip (SoC), such as an application processor. Data can be transmitted between host 402 and memory controller 404, between host 402 and processing memory 406, and memory controller 404 and memory device 408 each through a respective interlink 410, 411, and 413, such as a processor bus. In some examples, interlinks 410, 411, and 413 may apply same or different communication protocols. Host 402 may thus control the operations of processing memory 406 and memory controller 404.

Host 402 may coordinate operations in different modules/parts in system 40 based on data and/or signals transmitted from memory controller 404. Host 402 may control the operations of processing memory 406 based on data and/or signals transmitted from memory controller 404.

Memory device 408 may include arrays of memory cells that are configured to implement RAID algorithms following the core of the present disclosure. The RAID algorithms can utilize the non-integer striping configuration according to some implementations of the present disclosure. Memory device 408 can include, e.g., a 3D NAND memory, which transfers data with memory controller 404 through a corresponding interlink 410, 411, and 413. In some implementations, memory device 408 can include a 3D NAND memory having an array of 3D NAND memory cells. The array of 3D NAND memory cells can be formed by intersections of word lines and connection strings. The connection strings extend vertically above a substrate through a memory stack. NAND memory cells can be organized into pages, which are then organized into memory blocks. In one memory block, each NAND memory cell is electrically connected to a bit line (BL). Memory cells with the same horizontal level can be electrically connected through the control gates by a word line.

Processing memory 406 can serve as a system cache as an immediate-access space for frequently-used data and/or aid operations instructed by host 402 operations during tasks. In some implementations, processing memory 406 can include a Random-Access Memory (RAM), and it may be any suitable static random-access memory (SRAM) and/or dynamic random-access memory (DRAM). It can be understood that processing memory 406 in system 40 can be optional.

Memory controller 404 (a.k.a., a controller circuit) can be coupled to memory device 408 and host 402 and can be configured to control memory device 408, according to some implementations. For instance, memory controller 404 may be configured to operate the plurality of channel structures via the word lines. Memory controller 404 can manage the data stored or to be stored in memory device 408 and communicate with host 402. In some implementations, memory controller 404 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some implementations, memory controller 404 is designed for operating in a high duty-cycle environment SSDs or embedded multi-media-cards (eMMCs) used as data storage for mobile devices, such as smartphones, tablets, laptop computers, etc., and enterprise storage arrays. Memory controller 404 can be configured to control operations of memory device 408, such as read, erase, and program operations. Memory controller 404 can also be configured to manage various functions with respect to the data stored or to be stored in memory device 408 including, but not limited to bad-block management, garbage collection, logical-to-physical address conversion, wear leveling, etc. In some implementations, memory controller 404 can be further configured to process error correction codes (ECCs) with respect to the data read from or written to memory device 408. Any other suitable functions may be performed by memory controller 404 as well, for example, formatting 3D memory device 408. In accordance with the core of the present disclosure, memory controller 404 can be configured to receive data, generate parity information corresponding to the data, and control memory device 408 to store the parity information.

Memory controller 404 can communicate with host 402 according to a particular communication protocol. For example, memory controller 404 may communicate with host 402 through at least one of various interface protocols, such as a USB protocol, an MMC protocol, a peripheral component interconnection (PCI) protocol, a PCI-express (PCIe) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

Memory controller 404 and one or more memory devices 408 can be integrated into various types of storage devices, for example, be included in the same package, such as a universal Flash storage (UFS) package or an eMMC package. That is, memory system 400 can be implemented and packaged into different types of end electronic products. In one example as shown in FIG. 4B, memory controller 404 and a single memory device 408 may be integrated into a memory card 401. Memory card 401 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. Memory card 401 can further include a memory card connector 403 electrically coupling memory card 401 with host 402. In another example as shown in FIG. 4C, memory controller 404, and multiple memory devices 408 may be integrated into an SSD 405. SSD 405 can further include an SSD connector 407 electrically coupling SSD 405 with host 402. In some implementations, the storage capacity and/or the operation speed of SSD 405 is greater than those of memory card 401.

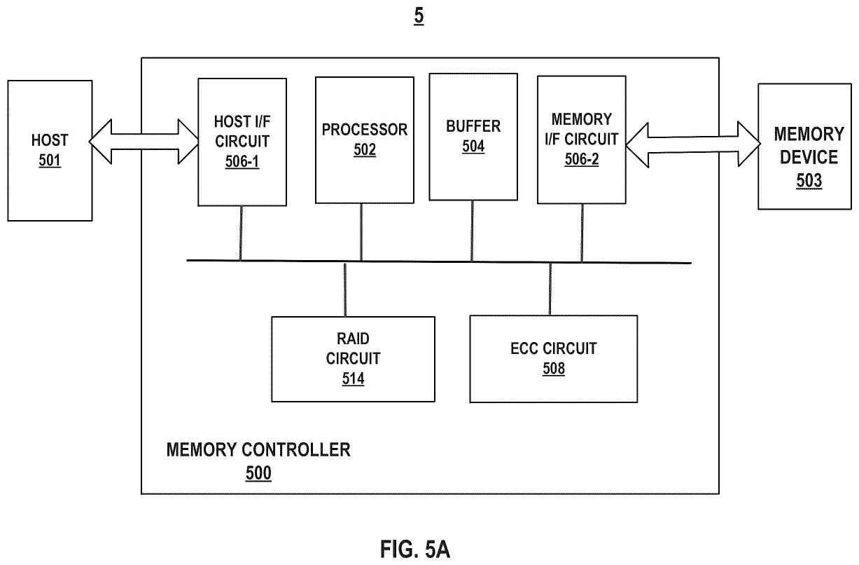

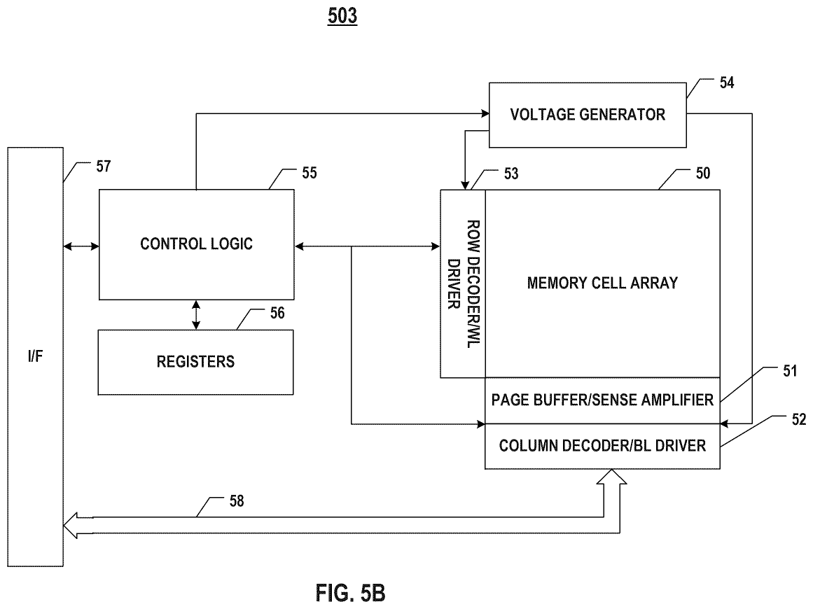

FIG. 5A illustrates a schematic diagram of an example memory controller 500 in collaboration with a host 501 and a memory device 503 for RAID processes, according to some aspects of the present disclosure. Memory controller 500, host 501, and memory device 503 can build up a memory system 5. Memory controller 500 can be an exemplary implementation of memory controller 404 in FIG. 4A, while host 501 and memory device 503 can be exemplary implementations of host 402 and memory device 408 in FIG. 4A, respectively.

Memory controller 500 may be configured to control operations of memory device 503 by generating control signals to control striping, computation of parity information, and storage of data to memory device 503. According to some implementations of the present disclosure, memory controller 500 can be configured to receive signals (e.g., instruction signals) from host 501 for performing operations with respect to memory device 503.

As shown in FIG. 5A, in some examples, memory controller 500 can include a processor 502, a buffer 504, and interface (I/F) circuits that include a host I/F circuit 506-1 and a memory I/F circuit 506-2. In some implementations, memory controller 500 may include different modules/circuits within it, such as an integrated circuit (IC) chip (implemented as, for example, an application-specific integrated circuit (ASIC) or a field-programmable gate array (FPGA)), or combine several electronic devices each with one or more dedicated functions. FIG. 5A is provided as an illustrative example to help understand some aspects of the present disclosure by showing processor 502, buffer 504, and the I/F circuits being integrated. However, this depiction should not be construed as limiting the physical placement of these components. In some implementations, the components of memory controller 500 may be distributed across different physical locations but communicate with each other over a network.

Processor 502 may include any appropriate type of general-purpose or special-purpose microprocessor, digital signal processor, or microcontroller. Processor 502 can be configured as a stand-alone processor module dedicated to analyzing signals (e.g., signals from host 501) and/or controlling scan schemes. Alternatively, processor 502 can be configured as a shared processor module for performing functions other than signal analysis/scan scheme control. In some implementations, processor 502 may include multiple functional units or modules that can be implemented using software, hardware, middleware, firmware, or any combination thereof. Consistent with some implementations of the present disclosure, processor 502 may be further configured to, in collaboration with other circuits, perform striping and computing, storing, and controlling parity data.

Buffer 504 can include any appropriate type of memory space provided to store information that processor 502 may need to operate on. Buffer 504 may be volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, a static RAM, a hard disk, an SSD, an optical disk, etc. Buffer 504 may be configured to store one or more computer programs that may be executed by processor 502 to perform functions regarding RAID processes disclosed in the present disclosure. For instance, buffer 504 may be configured to store program(s) that may be executed by processor 502 to, in collaboration with other circuits, generate RAID stripes, compute parity data, control storage of parity data, and perform recovery. In some implementations, buffer 504 may also be configured to store/cache information and data received and/or used by processor 502. For instance, buffer 504 may store/cache data received from host 501, and/or parity data generated during RAID processes. In some implementations, each buffer 504 configured to temporarily store parity information (e.g., as a RAID buffer) may associate with a limit (e.g., 320 KB). When the RAID parity data exceeds the limit, memory controller 500 can perform a swap operation.

Memory controller 500 can include the I/F circuits. In some examples, the I/F circuits may include host I/F circuit 506-1 operatively coupled to host 501, for example, through a processor bus, and configured to receive instructions from host 501. Host I/F circuit 506-1 can include a serial attached SCSI (SAS), parallel SCSI, PCI express (PCIe), NVM express (NVMe), advanced host controller interface (AHCI), and any suitable type. In some examples, the I/F circuits may also include memory I/F circuit 506-2. Memory I/F circuit 506-2 can include a single data rate (SDR) NAND Flash interface, open NAND Flash interface (ONFI), Toggle double data rate (DDR) interface, and any suitable type. In some implementations, memory I/F circuit 506-2 can be configured to transmit control signals to memory device 503 and receive data and status signals from memory device 503. The status signal can indicate the status of each operation performed by memory device 503 (e.g., failure, success, delay, etc.), which can be fed back to memory controller 500.

In some implementations, in the backend, memory controller 500 may include an ECC circuit 508, a garbage collection (GC) circuit, a bad block management circuit, and a RAID circuit 514. In some implementations, ECC circuit 508 can be configured to process error correction codes with respect to the data read from or written to memory device 503. The error correction codes may include, but are not limited to, Hamming codes, Reed-Solomon codes, low-density parity check (LDPC) codes.

In some implementations, when a read or program operation on a memory block in the memory device 503 fails, the garbage collection (GC) circuit in memory controller 500 can migrate valid data, including any associated parity data, from the failed memory block to another memory block. Under this situation, upon request, parity data from a corresponding stripe can be used to reconstruct missing data corresponding to the failed block. In some instances, after the data migration is complete, the bad block management circuit in memory controller 500 may mark the failed memory block as a bad block, ensuring it is no longer used for future data storage. Additionally, the GC circuit may update the associated parity data in the stripe to reflect new memory block locations.

In some implementations, processor 502 can instruct and configure RAID circuit 514 to perform striping and computing, storing, and controlling parity data in accordance with the core of the present disclosure. For instance, processor 502 may transmit data to RAID circuit 514 during a write operation, and processor 502 may further instruct RAID circuit 514 to process the data based on a striping strategy, thereby producing parity information. In other examples, when it fails to read a data portion (e.g., a failed data portion) from a corresponding page of memory device 503, processor 502 may instruct RAID circuit 514 to locate the data portion to obtain the other data portions and parity data portion in the same stripe as the data portion. Accordingly, a reconstructed data portion can be generated based on the other data portions and the parity portion in the same stripe to replace the failed data portion. As an example, in FIG. 5A, RAID circuit 514 is depicted as a separate module from processor 502. In some implementations, however, part or the entirety of processor 502 may function as a RAID circuit that performs part or the entirety of RAID processes. The present disclosure does not limit thereto.

FIG. 5B illustrates a schematic diagram of an example memory device 503 including a memory cell array 50 and peripheral circuits, according to some aspects of the present disclosure. The peripheral circuits can include various types of peripheral circuitry formed using complementary metal-oxide-semiconductor (CMOS) technologies. For instance, the peripheral circuits can include a page buffer 51, a column decoder/bit line driver 52, a row decoder/word line driver 53, a voltage generator 54, control logic 55, cache/registers 56, an interface (I/F) 57, and a data bus 58. It can be understood that in some examples, additional circuits can also be included, such as a sensing amplifier.

In some implementations, page buffer 51 can be configured to buffer data read from or programmed to memory cell array 50 according to control signals issued by control logic 55. Row decoder/word line driver 53 can be configured to be controlled by control logic 55 to select a block of memory cell array 50 and a word line WL of a selected block. Column decoder/bit line driver 52 may be controlled by control logic 55 to select one or more connection strings by applying a bit line voltage generated from voltage generator 54. Control logic 55 can be coupled to each peripheral circuit and configured to control the operations of the peripheral circuits. Cache/registers 56 can be coupled to control logic 55 and may include status registers, command registers, and address registers for storing status information, command operation codes, and command addresses for controlling the operations of each peripheral circuit. Interface 57 can be coupled to control logic 55 and configured to interface memory cell array 50 with a memory controller (e.g., memory controller 500). Voltage generator 54 may be controlled by control logic 55 to generate word line voltages (e.g., read voltage, programming voltage, pass voltage, local voltage, and verification voltage) and bit line voltages to be supplied to memory cell array 50.

Returning to FIG. 5A, host 501 can be configured to send or receive data to or from memory device 503. In order to send or receive data to or from memory device 503, host 501 can send instructions to memory controller 500, and memory controller 500 can communicate with host 501 according to specific communication protocols, such as PCIe or NVMe, which define the interconnection between host 501 and the memory system. Specifically, in write operations, memory controller 500 can receive data from host 501, which can include various types of information to be stored in memory device 503 (e.g., a NAND memory device), such as user data, metadata, or system logs. In certain implementations consistent with the present disclosure, under the control of processor 502 in memory controller 500, the data may undergo RAID processes to generate parity information. These processes may involve striping and encoding the data, which are used to ensure data redundancy and improve fault tolerance in the event of data corruption or memory block failure.

Once the data is prepared for storage, host 501 can generate corresponding write instructions. The write instructions, along with the data, can be transmitted to memory controller 500 via host I/F circuit 506-1. Subsequently, host I/F circuit 506-1 of memory controller 500 can forward the associated write instructions to processor 502 for further processing the data. For example, processor 502 may e.g., instruct RAID circuit 514 to determine stripes, generate the parity information, and recover data using the parity information. In some implementations, processor 502 can be configured to process the write instructions to enable memory controller 500 to work with memory device 503 for executing necessary write cycles to securely store the data and the parity information in memory device 503.

In some implementations, host 501 in FIG. 5A can be configured to generate write instructions and send the write instructions, together with data, to memory controller 500. Once memory controller 500 receives the data, memory controller 500 can be responsible for managing how the data is organized, including determining the striping pattern and distributing the data across different blocks or planes of memory device 503. In the present disclosure, the term “striping” is used to refer to splitting the data into segments, distributing these segments (along with parity information) across multiple planes in memory device 503, and associating these segments to generate parity information.

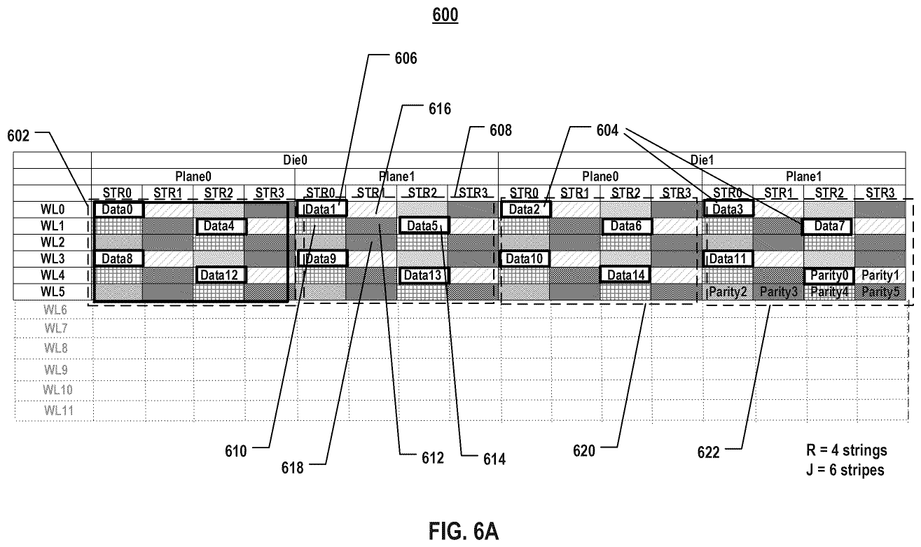

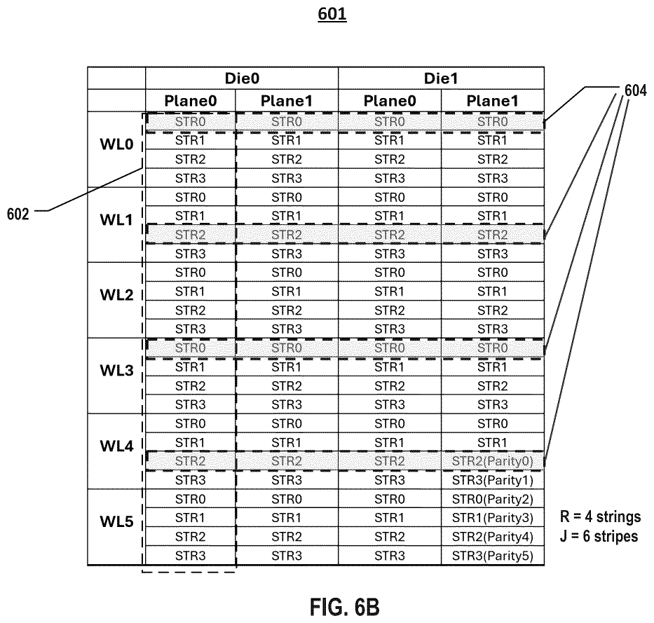

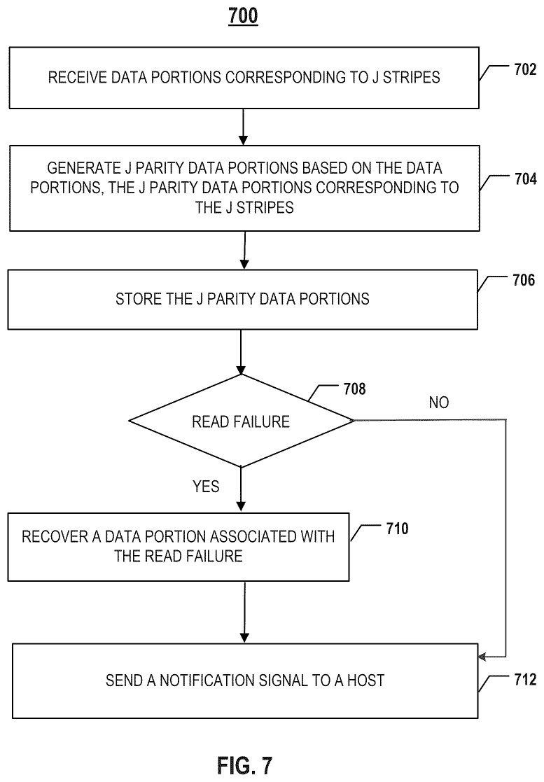

FIG. 6A illustrates a schematic diagram of a first example data structure and non-integer striping configuration for a RAID algorithm implemented in a memory device 600, according to some aspects of the present disclosure. FIG. 6B illustrates a schematic diagram of the first exemplary striping configuration of FIG. 6A from another perspective 601, according to some aspects of the present disclosure. FIG. 7 illustrates a flowchart of an exemplary method 700 for operating a memory device, according to some aspects of the present disclosure. In the following descriptions, some implementations of the present disclosure will be described with reference to FIGS. 5A, 6A, 6B, and 7.

In the present disclosure, the term “non-integer” is used to describe that, in one plane where each word line is coupled to R strings to form R pages laterally (including the first page coupled to string STR0, the second page coupled to string STR1, the third page coupled to string STR2, . . . , and the R^{th} page coupled to string STR_{R-1}), the number of pages for storing parity data portions may be arranged to be between R pages (corresponding to 1-WL protection) and 2R pages (corresponding to 2-WL protection). It can be understood that the non-integer striping configuration implemented in memory device 600 and according to method 700 are not exhaustive and that other striping configurations and methods can also be performed to reach the same/similar purposes in accordance with the core of the present disclosure. Details will be described later.

In some implementations, memory controller 500 can be configured to determine J stripes based on a striping group, where J is an integer. Each of the J stripes can correspond to one parity data portion, The term “striping group” is used to describe all pages to be striped and can be distributed in each plane of each die. In some implementations, the value of J can be determined according to various factors, such as the volume and importance of data to be stored. In some instances, the value of J can be a multiple of the value of R, with the multiple being greater than 1 and less than 2. Thus, the ratio of J to R is non-integer. R can represent the number of strings coupled to one word line in one plane. Accordingly, R is an integer. In some implementations, according to a programming failure distribution associated with a memory device, the ratio of J to R can be determined.

In some implementations, the ratio of J to R can include a number greater than 1 and less than 2. That is, the ratio is not an integer. For instance, the ratio of J to R can be 1.5. In other instances, the ratio can be 1.25, 1.75, 1.3, or another value between 1 and 2. The non-integer striping implies that the storage for the J parity data portions, determined from the striping group, may require more than R pages and less than 2R pages. This non-integer striping configuration can address most two word-line leakage issues and provide the coverage of most DPPM issues with a relatively reasonable size of RAID buffer, while reducing the buffer occupancy and maintaining performance.

In some instances, the programming failure distribution may include at least one of a Defective Parts Per Million (DPPM) distribution or a pattern-sensitive fault distribution. DPPM is a metric used to quantify the number of defective components in a batch of one million parts, and it is commonly used to assess the quality and reliability of products, including memory devices. DPPM value can be influenced by pattern-sensitive faults. Pattern-sensitive faults are defects in memory devices that are triggered by specific patterns of data. Unlike random defects, pattern-sensitive faults may depend on the interaction of data in neighboring memory cells. For instance, writing a certain pattern may cause corruption in nearby memory cells, especially in tightly stacked modern memory cell arrays.

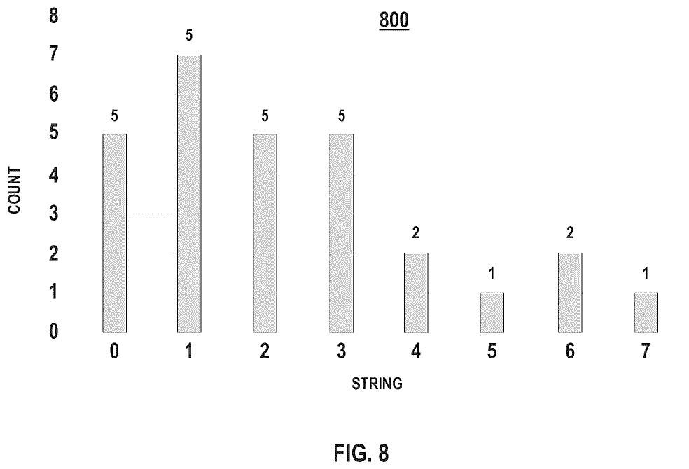

FIG. 8 illustrates a bar diagram showing a programming failure distribution 800 among different strings in a memory device, according to some aspects of the present disclosure. Programming failure distribution 800 in FIG. 8 can be pattern-sensitive. For instance, most of the programming failures in FIG. 8, particularly in regard to word-line and word-line short failures, occur among string 0 to string 3. In some examples, based on programming failure distribution 800, the striping strategy and pattern consistent with some implementations of the present disclosure can be accordingly determined.

From related research, it is found that in the application of 3D NAND memory device, when a memory system is performing program operations, a programming status failure (PSF) will occur due to, e.g., word-line leakage. For instance, it may occur when performing multi-plane programming. If a certain memory block in a plane causes PSF due to the existence of word-line leakage, the leakage will affect the voltage on the x-path (the voltage applied to a word line) in the entire multi-plane programming operation. When the voltage applied to the word line is affected, the data in the memory cells corresponding to the entire word line can be influenced. Since each word line may correspond to memory cells in multiple strings, a large amount of data may be lost or damaged, which may cause failures in the memory system. This type of failure is generally defined as a reliability failure of a 3D NAND memory device, which may further cause a failure of the memory system.

In 3D NAND memory device, the internal voltage supply is usually shared between different planes during program operations in order to save circuit area and reduce power consumption. When one memory plane is defective, other memory planes that share the internal voltage supply may not reach the target level. In other words, a PSF in one memory plane will also affect the voltages on the x-path in other adjacent memory planes, thus affecting the written data in the other adjacent memory planes. As a result, even when only one plane has physical defects, failures in read operations can often occur on multiple memory planes. That implies that failures in a memory device can be pattern-sensitive. This phenomenon is called Neighbor Plane Disturbance (NPD), which can cause data loss.

Referring to FIG. 7, method 700 starts at operation 702. At operation 702, memory controller 500 in FIG. 5A can receive data portions for generating parity information. In some implementations, the data portions may come from host 501 with write instructions. The data portions can correspond to J stripes, and each of the J stripes can correspond to one parity data portion.

With reference to FIG. 6A, memory device 600 can be an implementation of memory device 503 in FIG. 5B and can include a NAND memory device. For ease of illustration, NAND memory device 600 in FIG. 6A is represented in a tabular format. Additionally, NAND memory device 600 can be simplified to illustrate two planes of a die and four memory strings per plane. In this example, data is to be stored in two die (“Die0” and “Die1”) each having two planes (“Plane0” and “Plane1”). Each plane can include one or more memory blocks configured to store the data. Each memory block can correspond to six word lines arranged vertically, as shown in FIG. 6A (“WL0” to “WL5”), and each word line can be coupled to four strings (“STR0,” “STR1,” “STR2,” and “STR3”) in each plane to form four pages.

In various implementations, a memory device may have more than two dies, and each die may have more than two planes. Each memory block can include more than six word lines, and each word line can be coupled to more than four strings to form more than four pages. Therefore, it can be understood that FIG. 6A can depict part or the entirety of the data to be stored in memory device 600. In other words, FIG. 6A may depict one striping group only. For instance, broken lines in FIG. 6A are used to indicate that memory device 600 may include additional pages for another striping group. That is, the pages shown in solid portions are in one striping group, and there may be one or more other striping groups. The one or more striping groups can be striped identically or similarly according to the first striping group.

Additionally, FIG. 6A may show the exemplary striping configuration where the SLC technology is implemented. It is apparent that the striping configuration in FIG. 6A can also be applied to the MLCs, the TLCs, or the QLCs. For instance, when the TLC technology is applied to the memory cells, each physical page in FIG. 6A can correspond to three logic pages for storing upper page (UP) data portions, middle page (MP) data portions, and lower page (LP) data portions.

In the example provided by FIG. 6A, all subsets of pages in each plane of each die (i.e., this striping group) can participate in generating the J stripes. The term “subsets of pages” is used to describe all pages to be striped and can include all pages in this striping group. As shown in FIG. 6A, in one plane, one word line is coupled to four strings to form four pages, representing that the value of R is 4. When the ratio of J to R is determined to be 1.5, for example, memory controller 500 can be responsible for determining 4×1.5=6 stripes. In other words, the value of J (representing the number of stripes) can be 6. In some implementations, at the end of each stripe 604, a parity data portion, corresponding to one of the six stripes, can be stored. However, in some implementations, the parity data portions can be stored in other memory locations, such as a dedicated memory block. To maintain a data-to-parity ration of 15:1 as that in 1-WL protection in FIG. 2A or 2-WL protection in FIG. 3A for comparisons, 15 data portions (e.g., Data0 to Data14 in FIG. 6A) can be encoded to generate 1 parity data portion (e.g., Parity0), as shown in FIG. 6A.

Method 700 may proceed to operation 704, where J parity data portions can be generated based on the data portions received by memory controller 500 in FIG. 5A. In some implementations, one stripe can include one parity data portion. In the example of FIG. 6A, 15 data portions can be used to generate one parity data portion. In some implementations, processor 502 in memory controller 500 can, e.g., instruct RAID circuit 514 to process the 15 data portions and calculate one parity data portion based on the 15 data portions and RAID algorithm(s). The parity data portion for a stripe 604 shown in FIG. 6A can be derived from an encoding operation. In some instances, a series of XOR operations can be performed on the 15 data portions corresponding to stripe 604. For data portions Data0, Data1, . . . , and Data14 to be stored in 15 pages of stripe 604, the parity data can be generated by:

$$Parity 0 = ( Data 0 ) XOR ( Data 1 ) XOR ( Data 2 ) … XOR ( Data 14 ) . \qquad ( 3 )$$

The parity data portion, serving as a form of redundancy, is used to reconstruct lost or damaged data in the event of a read failure. In FIG. 6A, to maintain the clarity of the illustration, the indicator is only connected to a portion of the stripe.

Method 700 proceeds to operation 706. At operation 706, the J parity data portions and the data portions may be stored in memory device 503. In some implementations, memory controller 500 can be configured to store the original data portions and the parity data portions based on respective stripes, distributing these data portions across different memory pages, either in the stripes or in other memory locations. This approach ensures that all necessary data, including the parity information, is available for subsequent recovery when necessary.

After the initial program operations, when changes are made to the stored data, the parity information can also be updated accordingly, e.g., through the GC circuit. Whenever the data is modified, memory controller 500 can be configured to recalculate the parity data portions based on the new data, ensuring that the stored parity information can remain in synchronization with the updated data. The real-time update of the parity information can ensure continuous protection of the data throughout its lifecycle in memory device 503, maintaining the integrity and reliability of the stored data.

At operation 708, a read failure, associated with a particular data portion, may occur. The failure can arise from various types of issues. For instance, when memory controller 500 encounters a problem during a program operation on data, it may be recognized that the data was not properly written into the memory block. Subsequently, when memory controller 500 attempts to read the stored data, a read failure can be encountered. At operation 710, processor 502 in memory controller 500 may instruct RAID circuit 514 to locate the data portion that has become corrupted or is unreadable, according to the read failure. Based on the unreadable data portion, the remaining data portions and a parity data portion in the same stripe can be located. In some implementations, processor 502 can, e.g., instruct RAID circuit 514 in FIG. 5A to manage recovery processes using the remaining data portions and the parity data portion that are still accessible in the same stripe to reconstruct a new data portion corresponding to the unreadable data portion.

For instance, in the event of a read failure associated with one data portion of the stripe (e.g., Data0 in FIG. 6A), recovery can be achieved by performing a decoding operation using the parity data and the remaining data portions (e.g., from Data1 to Data14). For example, a series of XOR operations can be performed on the parity data and the remaining data portions. Based on FIG. 6A, when data portion Data2 fails, a reconstructed data portion corresponding to data portion Data2 can be generated by:

$$( Datat 2 ) = Parity 0 XOR ( data 0 ) XOR ( Data 1 ) XOR ( Data 3 ) … XOR ( Data 14 ) . \qquad ( 4 )$$

In some implementations, RAID can be utilized to address program failure scenarios by the data recovery mechanisms. For instance, when a program failure occurs during the process of writing data to a memory block, resulting in a corrupted or incomplete data portion, RAID circuit 514 can identify the affected data based on its error detection mechanisms. By referencing the remaining data portions and the parity data portion in the same stripe, RAID circuit 514 can reconstruct the corrupted or missing data portion. This recovery process ensures data integrity and reliability when program operations fail.

In some implementations, after memory controller 500 has completed the recovery processes and restored a new data portion using the parity information, the new data portion can be written to a different location on memory device 503 through memory I/F circuit 506-2 to replace the unreadable data portion. In some implementations, the parity information may be recalculated to ensure that the redundancy mechanisms remain valid and effective for future error detection and recovery when necessary. In some implementations, memory controller 500 can be configured to recalculate the updated parity information for this stripe, which now includes the newly generated data.

At operation 712, when no read failure is detected, processor 502 may send a notification to host 501 through host I/F circuit 506-1. This notification can be configured to inform host 501 that not only was a failure recovered, but also that the parity information has been successfully updated or no read failure is further found, ensuring that the memory system remains fully protected against future failures. This arrangement would allow memory device 503 to log the events into its internal error tracking system, according to some implementations.

In some implementations, the present disclosure can provide a non-transitory computer-readable storage medium, for example, in memory controller 500 in FIG. 5A. The non-transitory computer-readable storage medium can store one or more program instructions that can be executed by processor 502 (e.g., firmware). When memory controller 500 executes the one or more program instructions, the operations according to method 700 can be performed.

In some implementations, processor 502 can instruct RAID circuit 514 to determine multiple data portions from a striping group to generate a parity data portion. In the example provided by FIG. 6A, the striping group can include four subsets of pages, including a first subset of pages 602 in Plane0 of Die0, a second subset of pages 608 in Plan1 of Die0, a third subset of pages 620 in Plane0 of Die1, and a fourth subset of pages 622 in Plane1 in Die1. First subset of pages 602, second subset of pages 608, third subset of pages 620, and fourth subset of pages 622 constitute all pages that participate in striping in FIG. 6A. In other words, these subsets of pages can constitute this striping group.

Taking FIG. 6A for example, processor 502 may instruct RAID circuit 514 to determine 15 data portions from a striping group, including first subset of pages 602 in Plane0 of Die0, second subset of pages 608 in Plan1 of Die0, third subset of pages 620 in Plane0 of Die1, and fourth subset of pages 622 in Plane1 in Die1. The 15 data portions (e.g., Data0 to Data14) to be stored in 15 pages can form a stripe 604, as shown in FIG. 6A. In some implementations, processor 502 may further instruct RAID circuit 514 to calculate a parity data portion using the 15 data portions. For example, a series of XOR operations can be performed on the 15 data portions to generate the parity data portion (e.g., “Parity0”). Processor 502 can generate write commands to store the 15 data portions and the parity data calculated according to Equation (3) in memory device 503. In some examples, the parity data portion can be stored in the last page of stripe 604 (e.g., the page corresponding to “Parity0” in FIG. 6A). In some examples, the parity data portion can be stored in another memory location, such as a dedicated memory block.

In certain memory systems, particularly in a NAND memory device, there are higher risks of short failures between two adjacent word lines. This type of failure occurs when electrical interference or leakage causes data corruption in memory cells located between two physically adjacent word lines. This corruption can lead to the loss or alteration of stored data, making it inaccessible or incorrect. To mitigate this risk and others and enhance the reliability of the memory system, memory controller 500 (e.g., through a firmware of memory controller 500) may be configured to impose specific rules for determining how pages of a stripe can be organized across word lines.

In some implementations, processor 502 can instruct RAID circuit 514 to follow certain striping approaches where pages corresponding to non-adjacent word lines are selected to form a stripe. In some implementations, processor 502 can be configured to consider a data structure and the potential adjacent word-line failures. In some implementations, the placement rules can be built into, for example, a firmware in memory controller 500.

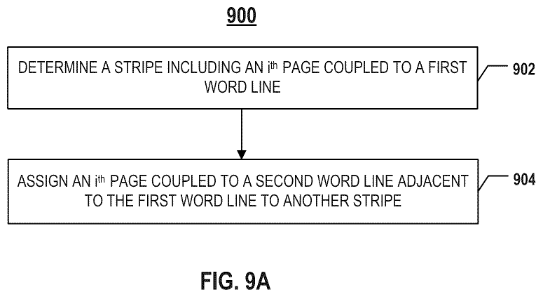

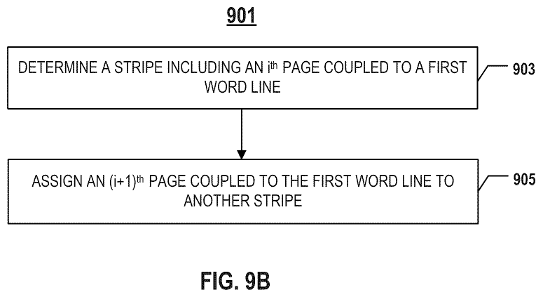

FIGS. 9A and 9B illustrate flowcharts of example methods for determining stripes, according to some aspects of the present disclosure. At operation 902 in method 900 of FIG. 9A, in one subset of pages of one plane, when determining that an i^{th} page, coupled to the first word line, is included in one stripe of the J stripes, processor 502 further determines that another stripe can include an i^{th} page coupled to the second word line adjacent to the first word line, at operation 904. In other words, in the subset of pages of one plane, two i^{th} pages coupled to two adjacent word lines may belong to different stripes of the J stripes. Herein, the term “two i^{th} pages” is used to refer to two pages in the same string/section (i.e., having the same string index) of the same plane. Additionally, herein, the term “a page included in a stripe” is used to describe that a data portion to be stored in the page can participate in generating the stripe. In some implementations, the J parity data portions can be generated in parallel based on the striping group.

Taking FIG. 6A for exemplary description, when processor 502 determines that a page 606 (i.e., the first page coupled to word line WL0 in a subset of pages 608) is included in the first stripe, processor 502 can assign a page 610 coupled to word line WL1 adjacent to word line WL0 to the second stripe different from the first stripe. That is, page 606 and page 610 can be assigned to two different stripes.

In terms of physical locations, page 606 in FIG. 6A can be equivalent to PAGE1 in FIG. 2B, while page 610 in FIG. 6A can be equivalent to PAGE2 in FIG. 2B. In some implementations, a data portion corresponding to PAGE1 and another data portion corresponding to PAGE2 can be assigned to different stripes. As there are higher risks of short failures between two adjacent word lines, this placement of pages that are coupled to two adjacent word lines to different stripes can mitigate a word-line and word-line short failure and thus enhance the reliability of the memory system.

In some implementations, processor 502 can assign two adjacent pages coupled to the same word line to different stripes. This striping approach may address the potential risk that a failure affecting a single word line could result in the corruption of multiple pages stored on that word line. At operation 903 in method 901 of FIG. 9B, in one subset of pages of one plane, when determining that an i^{th} page, coupled to the first word line, is included in one stripe of the J stripes, processor 502 can further determine that another stripe includes an (i+1)^{th} page coupled to the same first word line, at operation 905. In other words, in the subset of pages, two adjacent pages coupled to the same word lines may belong to different stripes of the J stripes.

Taking FIG. 6A for exemplary description, when processor 502 determines that a page 606 (i.e., the first page coupled to word line WL0 in a subset of pages 608) is included in the first stripe, processor 502 can assign a page 616, adjacent to page 606, coupled to the same word line WL0 to the second stripe. That is, page 606 and page 616 can belong to two different stripes. In terms of physical locations, returning to FIG. 2B, page 606 in FIG. 6A can be equivalent to PAGE1 in FIG. 2B, while page 616 in FIG. 6A can be equivalent to PAGE6 in FIG. 2B.

In some implementations, in one subset of pages, each of the first page, the second page, and the third page, coupled to the same word line, may belong to a respective stripe of the J stripes. The second page and third page can be adjacent to the first page coupled to the same word line. In some implementations, in one subset of pages, each of the fourth page, the fifth page, and the sixth page, respectively coupled to the first word line, the second word line, and the third word line, can belong to a respective stripe of the J stripes. The first line and third word line are adjacent to the second word line. Further, the fourth page, the fifth page, and the sixth page are included in the same string.

In some implementations, in one subset of pages 608 of FIG. 6A, processor 502 may assign page 612 and its neighboring pages 610 and 614, coupled to the same word line WL1 and arranged laterally in different strings, to three different stripes of the 6 stripes. In some implementations, processor 502 can assign page 612 and its neighboring pages 616 and 618, arranged vertically in the same string and coupled to three different word lines, to three different stripes.

In some implementations, processor 502 may apply these striping approaches as striping patterns to all subsets of pages. For instance, the striping pattern may be applied to the first stripe (corresponding to K pages and K being an integer) that includes the first set of pages and the second set of pages. The first set of pages may include, from each subset of pages, an i^{th} page coupled to a k^{th} word line, where 1≤i≤R. The second set of pages may include, from each subset of pages, a j^{th} page coupled to a (k+1)^{th} word line, 1≤j≤R, and j≠i. It can be understood that the (k+1)^{th} word line is a word line adjacent to the k^{th} word line. The k^{th} word line and (k+1)^{th} word line are among the multiple word lines in one plane.

For instance, in FIG. 6A, the first set may include the 1^{st} pages coupled to word line WL0 (including Data0, Data1, Data2, and Data3 to be stored in STR0) from each subset of pages 602. In order to reduce a word-line and word-line short failure, pages corresponding to a string different from STR0 can be selected in the same stripe. For instance, the 3^{rd} page coupled to word line WL1 (including Data4, Data5, Data6, and Data7 to be stored in STR2) can be determined to be the second set of the first stripe.

In some implementations, the stripe may include the third set of pages and the fourth set of pages. The third set of pages may include, from each subset of pages, an i^{th} page coupled to a k^{th} word line of the multiple word lines, 1≤i≤R. The fourth set of pages may include, from each subset of pages, an i^{th} page coupled to a (k+n)^{th} word line of the multiple word lines, n>1. That is, the (k+n)^{th} word line is not a word line adjacent to the k^{th} word line. The k^{th} word line and (k+n)^{th} word line are among the multiple word lines in one plane.

For instance, in FIG. 6A, the first set of pages may include the first pages coupled to word line WL0 (including Data0, Data1, Data2, and Data3 to be stored in STR0) from each subset of pages. Subsequently, pages, coupled to the non-adjacent word line, from the same section may be selected for this stripe. For instance, the fourth set may include pages coupled to word line WL3 (including Data8, Data9, Data10, and Data11), in the same string, from each subset of pages. By organizing pages of a stripe according to the pattern, the memory system can increase its resilience to common physical failures.

FIG. 6B illustrates a schematic diagram of the example striping configuration of FIG. 6A from another perspective 601, according to some aspects of the present disclosure. Subset of pages 602 and stripe 604 in FIG. 6A are illustrated from a different perspective in FIG. 6B. As shown in FIGS. 6A and 6B, in one plane, a word line is coupled to four strings, resulting in R being equal to 4. Further, as six stripes in total are generated based on this striping group, J can be equal to 6, resulting in a ratio of J to R being equal to 1.5.

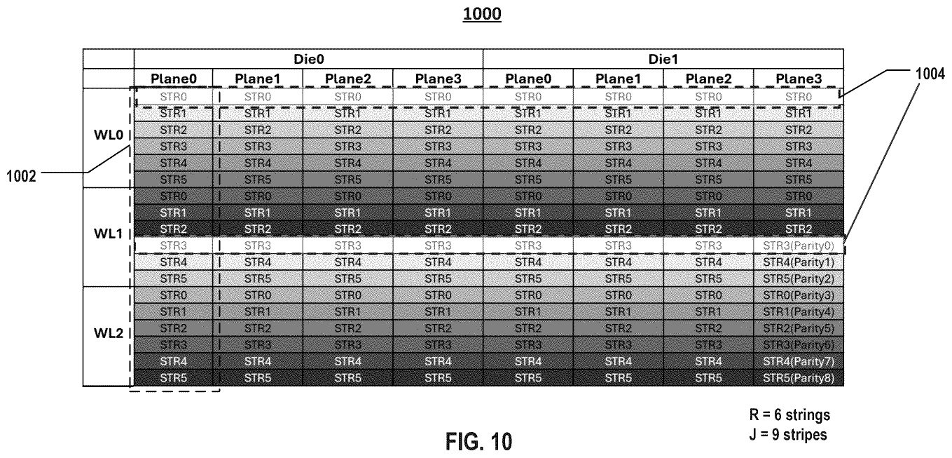

FIG. 10 illustrates a schematic diagram of a third example data structure and non-integer striping configuration for a RAID algorithm implemented in a memory device 1000, according to some aspects of the present disclosure. Based on each subset of pages 1002, nine stripes 1004 are generated. FIG. 10 is another example showing the ratio of J to R equal to 1.5 with different values of J and R and data structures. For example, J=9, R=6, and each die can include 4 planes, as shown in FIG. 10.

The non-integer striping configurations provided by the present disclosure, however, are not limited to 1.5-WL protection (i.e., not limited to the ratio of J to R equal to 1.5). In accordance with the core of the present disclosure, the ratio of J (i.e., the number of stripes) to R (i.e., the number of strings coupled to a word line in one plane can be a value greater than 1 and less than 2.

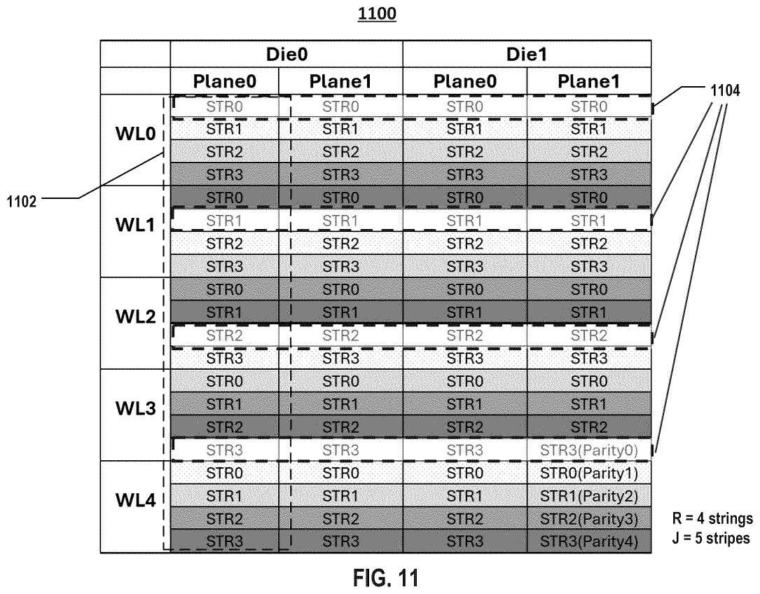

For instance, FIG. 11 illustrates a schematic diagram of a third example data structure and non-integer striping configuration for a RAID algorithm implemented in a memory device 1100, according to some aspects of the present disclosure. In some implementations, the ratio of J to R can be 1.25. In the example illustrated in FIG. 11, five stripes can be generated based on each subset of pages 1102 in each plane of each die. That is, J is 5, although in FIG. 11, only one stripe 1104 is annotated. As shown in FIG. 11, the number of strings coupled to a word line in one plane can be 4. Namely, R is 4. In each stripe, 15 data portions are used to produce one parity data portion, maintaining the data-to-parity ratio of 15:1.

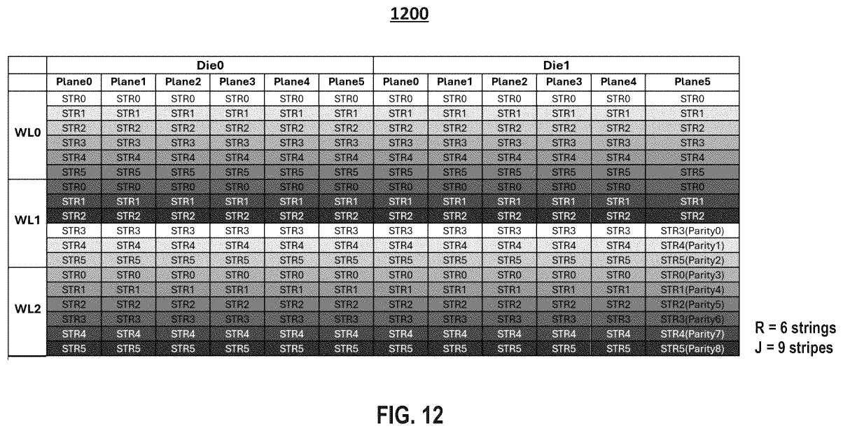

It should be understood that the data-to-parity ratio of 15:1, as described in some implementations of the present disclosure, is provided to facilitate fair comparisons across different striping configurations on a common baseline. However, the present disclosure is not limited to this specific ratio. In some implementations, the data-to-parity ratio may differ from 15:1. For instance, FIG. 12 illustrates a schematic diagram of a fourth example data structure and non-integer striping configuration for a RAID algorithm implemented in a memory device 1200, according to some aspects of the present disclosure. FIG. 12 shows the ratio of J to R is 1.5, where J (the number of stripes) is equal to 9, and R (the number of strings coupled to a word line in one plane) is equal to 6. In the example of FIG. 12, the data-to-parity ratio is 23:1, rather than 15:1.

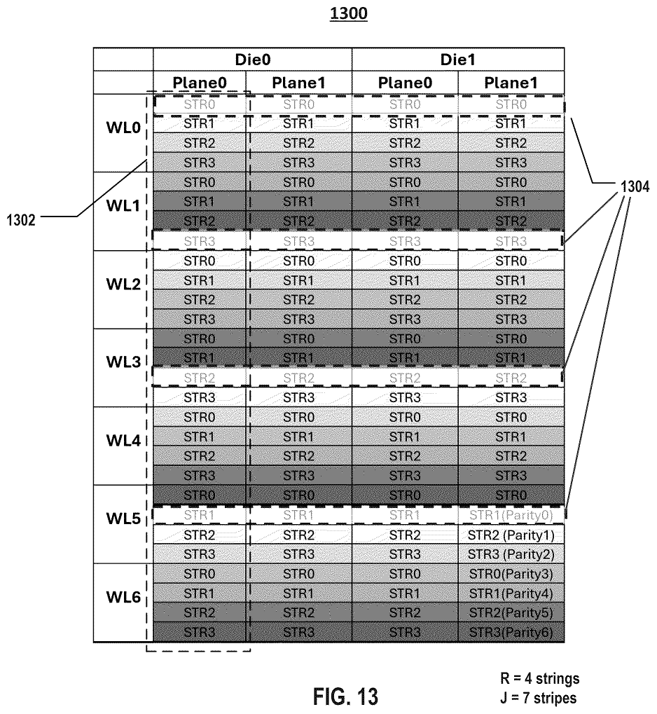

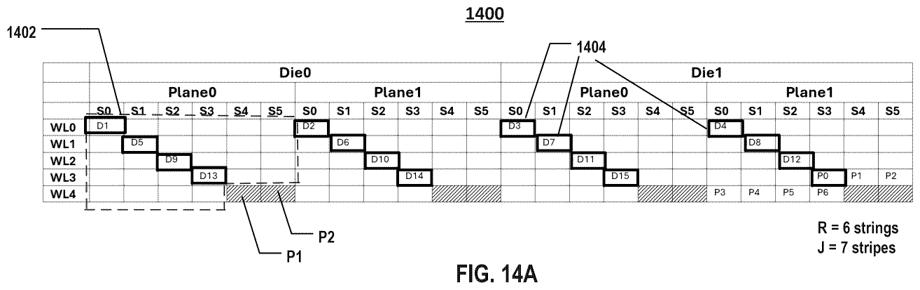

FIG. 13 illustrates a schematic diagram of a fifth example data structure and non-integer striping configuration for a RAID algorithm implemented in a memory device 1300, according to some aspects of the present disclosure. Based on subsets of pages 1302 in each plane of each die (i.e., a striping group), seven stripes are generated, although in FIG. 13, only one stripe 1304 is annotated. Hence, J is equal to 7. As shown in FIG. 13, four strings are coupled to a word line in one plane, turning R to be equal to 4. Accordingly, the ratio of J to R can be 1.75. According to FIG. 13, 15 data portions are used to generate one parity data portion, maintaining the data-to-parity ratio at 15:1 for the comparison.

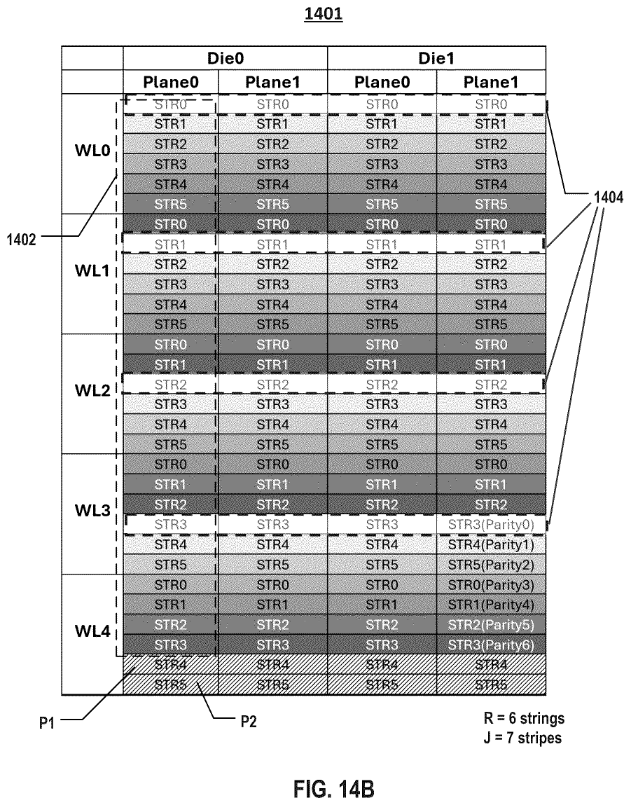

It can be understood that in some implementations of the present disclosure, a subset of pages may not cover all pages coupled to the multiple word lines in one plane. FIG. 14A illustrates a schematic diagram of a sixth exemplary data structure and non-integer striping configuration for a RAID algorithm implemented in a memory device 1400, according to some aspects of the present disclosure. As shown in FIG. 14A, a subset of pages 1402 is not rectangular, resulting in a page P1 (a string S4 coupled to word line WL4) and a page P2 are not included in subset of pages 1402 for this striping group. It can be understood that due to each subset of pages 1402 not being a regular shape, the number of the multiple word lines in this striping group (corresponding to a parameter Q) is not an integer, turning the value of Q to be 4.67. Q can represent the number of word lines that are coupled to one subset of pages in a striping group. In some implementations, memory device 1400 may include one or more other striping groups. Unstriped pages P1 and P2 may be included in one of these striping groups.

Based on the first striping group in FIG. 14A, seven stripes are generated, although in FIG. 14A, only one stripe 1404 is annotated. Hence, J is equal to 7. As shown in FIG. 14A, six strings are coupled to a word line in one plane, turning R to be equal to 6. Accordingly, the ratio of J to R approaches 1.167. According to FIG. 14A, 15 data portions are used to generate one parity data portion, maintaining the data-to-parity ratio at 15:1. FIG. 14B illustrates a schematic diagram of the sixth exemplary striping configuration of FIG. 14A from another perspective 1401, according to some aspects of the present disclosure. Subset of pages 1402, stripe 1404, and unstriped pages P1 and P2 in FIG. 14A are illustrated in a different perspective in FIG. 14B.

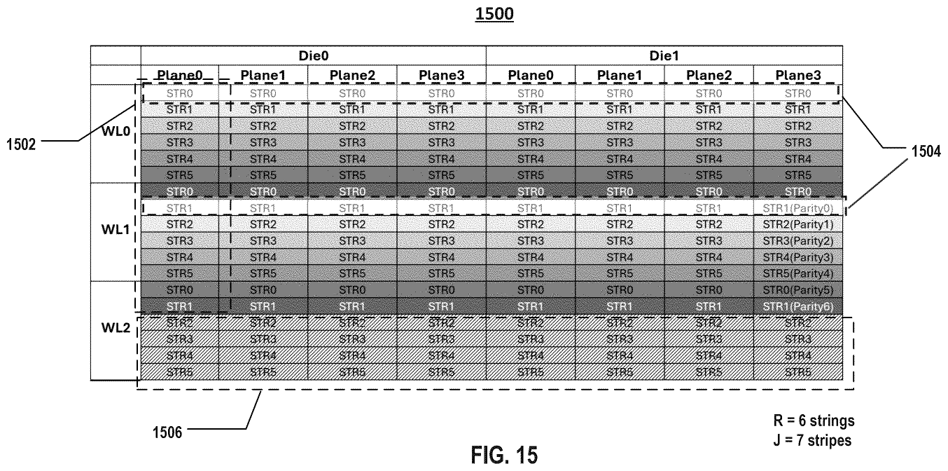

FIG. 15 illustrates a schematic diagram of a seventh example data structure and non-integer striping configuration for a RAID algorithm implemented in a memory device 1500, according to some aspects of the present disclosure. FIG. 15 shows another example, in which some pages are not striped and do not participate in a striping group. For instance, a region covering certain pages 1506 coupled to word line WL2 in FIG. 15 are not striped in a striping group. Based on subsets of pages 1502 in each plane of each die, seven stripes 1504 are generated. Hence, J is equal to 7. As shown in FIG. 15, six strings are coupled to a word line in one plane, turning R to be equal to 6. Accordingly, the ratio of J to R can be 1.167. According to FIG. 15, 15 data portions are used to generate one parity data portion, maintaining the data-to-parity ratio at 15:1. It can be understood that because some pages coupled to certain word lines in this striping group do not participate in this striping group, the number of word lines in this striping group is not an integer, turning the value of Q to be 2.3.

In view of the above, it can be understood that the present disclosure does not limit the values of J and R as well as the data structures. In some implementations, the values of J, R, and other parameters (e.g., Q) may be flexibly determined according to actual requirements. In accordance with the core of the present disclosure, the ratio of J to R can include a value greater than 1 and less than 2.

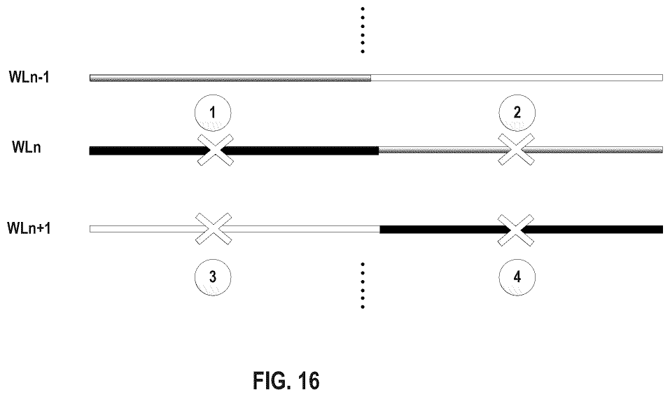

FIG. 16 illustrates a schematic diagram of a data recovery protection of an example non-integer striping configuration, according to some aspects of the present disclosure. In this non-integer striping example, portions of three adjacent word lines WLn−1, WLn, and WLn+1 may be included in three stripes shown in different gray-scale levels. When a PSF occurs at position \textcircled{1} and affects two portions, above it, coupled to word line WLn−1, this failure can be corrected based on this non-integer striping. The reason is that the failed portion at position \textcircled{1} and the two failed portions corresponding to word line WLn−1 above it belong to three different stripes. As a result, based on this striping strategy, the data portions in these three positions can all be recovered. Similarly, when a PSF occurs at position \textcircled{3} and affects positions \textcircled{1} and \textcircled{2} coupled to word line WLn, this failure can also be fixed. When a PSF occurs at position \textcircled{4} and affects positions \textcircled{1} and \textcircled{2} above it, due to the failed portions at positions \textcircled{4} and \textcircled{1} belonging to the same strip, this failure cannot be corrected. Notably, although the protection for the PSFs at position \textcircled{4} may be less, the occurrences of word-line and word-line short failures at this position are also relatively small, as shown in FIG. 10. As a result, this non-integer striping strategy provides sufficient data protection to improve the reliability of a memory device.

According to some implementations of the present disclosure, based on Defective Parts Per Million (DPPM) distribution, protection strategies with reasonable cost may be adopted while reducing the impact on performance. Accordingly, striping based on integer multiples of word lines may not be necessary. The striping configuration may be customized according to actual requirements. In accordance with some implementations of the present disclosure, non-integer striping configurations that cover most word-line leakage issues are obtained. The non-integer striping configurations can provide the coverage of most DPPM issues with a relatively reasonable usage of RAID buffer, while reducing the buffer occupancy on the performance aspects.

The foregoing description of the specific implementations will reveal the general nature of the present disclosure that others can, by applying knowledge within the skill of the art, readily modify and/or adapt for various applications such specific implementations, without undue experimentation, without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Implementations of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary implementations of the present disclosure as contemplated by the inventor(s), and thus, are not intended to limit the present disclosure and the appended claims in any way.

The breadth and scope of the present disclosure should not be limited by any of the above-described exemplary implementations, but should be defined only in accordance with the following claims and their equivalents.

1. A memory system, comprising:
a memory device, comprising one or more dies each comprising a plurality of planes, wherein:
each of the plurality of planes comprises a subset of pages corresponding to multiple word lines, the plurality of planes of the one or more dies forming a striping group in the one or more dies, one word line of the multiple word lines being coupled to R strings in each plane to form R pages; and
the striping group forms J stripes, each of R and J being an integer, and a ratio of J to R being a value greater than 1 and less than 2, wherein the R strings, coupled to a word line of the multiple word lines in one plane, belong to different stripes of the J stripes; and
a memory controller coupled with the memory device and configured to:
receive data portions corresponding to the J stripes;
generate J parity data portions based on the data portions; and
control the memory device to store the J parity data portions.

2. The memory system of claim 1, wherein:
the ratio of J to R is equal to 1.5.

3. The memory system of claim 1, wherein the memory controller is further configured to:
according to a programming failure distribution associated with the memory device, determine the ratio of J to R.

4. The memory system of claim 1, wherein:
in the subset of pages, two i^{th} pages of a same string, coupled to two adjacent word lines of the multiple word lines, belong to two stripes of the J stripes, 1≤i≤R.

5. The memory system of claim 1, wherein:
in the subset of pages, two adjacent pages, coupled to a same word line of the multiple word lines, belong to two stripes of the J stripes.

6. The memory system of claim 1, wherein:
in the subset of pages, each of a first page, a second page, and a third page, coupled to a same word line, belongs to a respective stripe of the J stripes, the second page and the third page being adjacent to the first page that corresponds to the same word line.

7. The memory system of claim 1, wherein:
in the subset of pages, each of a fourth page, a fifth page, and a sixth page, respectively coupled to a first word line, a second word line, and a third word line, belongs to a respective stripe of the J stripes, wherein:
the first word line and third word line are adjacent to the second word line; and
the fourth, fifth, and sixth pages correspond to a same string.

8. The memory system of claim 1, wherein the memory controller is further configured to perform an encoding operation on the data portions to generate the J parity data portions.

9. The memory system of claim 1, wherein the memory controller is further configured to:
receive a first data portion corresponding to a first page of the subset of pages, and a second data portion corresponding to a second page of the subset of pages; and
perform an exclusive OR (XOR) operation on the first data portion and the second data portion.

10. The memory system of claim 1, wherein the memory controller is further configured to in response to a read failure associated with a third data portion:
locate the third data portion, corresponding to the read failure, in the memory device;
obtain remaining data portions and a first parity data portion in a stripe with the third data portion;
generate a reconstructed data portion based on the first parity data portion and the remaining data portions; and
replace the third data portion with the reconstructed data portion.

11. A memory controller, comprising:
an interface (I/F) circuit coupled with a memory device that comprises one or more dies each comprising a plurality of planes, wherein:
each of the plurality of planes comprises a subset of pages corresponding to multiple word lines, the plurality of planes of the one or more dies forming a striping group in the one or more dies, one word line of the multiple word lines being coupled to R strings in each plane to form R pages; and
the striping group forms J stripes, each of R and J being an integer, and a ratio of J to R being a value greater than 1 and less than 2, wherein the R strings, coupled to a word line of the multiple word lines in one plane, belong to different stripes of the J stripes; and
a processor coupled with the I/F circuit and configured to:
receive data portions corresponding to the J stripes;
generate J parity data portions based on the data portions; and
control the I/F circuit to send a write command, the data portions, and the J parity data portions to the memory device to store the J parity data portions and the data portions in the memory device.

12. The memory controller of claim 11, wherein:
the ratio of J to R is equal to 1.5.

13. The memory controller of claim 11, wherein:
a first stripe of the J stripes comprises a first set of pages and a second set of pages;
the first set of pages comprises, from each subset of pages, an i^{th} page coupled to a first word line of the multiple word lines, 1≤i≤R; and
the second set of pages comprises, from each subset of pages, a j^{th} page coupled to a second word line adjacent to the first word line, 1≤j≤R, and j≠i.

14. The memory controller of claim 11, wherein:
a first stripe of the J stripes comprises a third set of pages and a fourth set of pages;
the third set of pages comprises, from each subset of pages, an i^{th} page coupled to a first word line, 1≤i≤R; and
the fourth set of pages comprises, from each subset of pages, an i^{th} page coupled to a third word line that is non-adjacent to the first word line.

15. The memory controller of claim 11, wherein the processor is further configured to, in response to a read failure associated with a third data portion:
locate the third data portion, corresponding to the read failure, in the memory device;
obtain remaining data portions and a first parity data portion in a stripe with the third data portion;
generate a reconstructed data portion based on the first parity data portion and the remaining data portions; and
control the I/F circuit to send the reconstructed data portion to the memory device to store the reconstructed data portion in the memory device.

16. The memory controller of claim 11, wherein the processor is further configured to generate the J parity data portions in parallel.

17. A method for Redundant Device of Independent Disks (RAID) striping, implemented in a memory device that comprises one or more dies each comprising a plurality of planes, wherein:
each of the plurality of planes comprises a subset of pages corresponding to multiple word lines, the plurality of planes of the one or more dies forming a striping group in the one or more dies, one word line of the multiple word lines being coupled to R strings in each plane to form R pages; and
the striping group forms J stripes, each of R and J being an integer, and a ratio of J to R being a value greater than 1 and less than 2, wherein the R strings, coupled to a word line of the multiple word lines in one plane, belong to different stripes of the J stripes; and
the method comprises:
receiving data portions corresponding to the J stripes;
generating J parity data portions based on the data portions; and
controlling the memory device to store the J parity data portions.

18. The method of claim 17, wherein:
the ratio of J to R is equal to 1.5.

19. The method of claim 17, wherein:
in the subset of pages, each of a first page, a second page, and a third page, coupled to a same word line, belongs to a respective stripe of the J stripes, the second page and the third page being adjacent to the first page that corresponds to the same word line.

20. The method of claim 17, wherein:
in the subset of pages, each of a fourth page, a fifth page, and a sixth page, respectively coupled to a first word line, a second word line, and a third word line, belongs to a respective stripe of the J stripes, wherein:
the first word line and the third word line are adjacent to the second word line; and
the fourth, fifth, and sixth pages are included in a same string.
